(19) United States
(12) Patent Application Publication
(10) Pub. No.: US 2010/0194941 A1
(43) Pub. Date: Aug. 5, 2010

(54) LIGHT/ELECTRIC POWER CONVERTER AND SOLID STATE IMAGING DEVICE

(75) Inventors: Yoshiki MAEHARA, Kanagawa (JP); Mitsuji YOSHIBAYASHI, Shizuoka (JP)

Correspondence Address: Studebaker & Brackett PC, One Fountain Square, 11911 Freedom Drive, Suite 750, Reston, VA, 20190, US

(73) Assignee: FUJIFILM CORPORATION, Tokyo (JP)

(21) Appl. No.: 12/697,899

(22) Filed: Feb. 1, 2010

(30) Foreign Application Priority Data
Feb. 2, 2009 (JP) 2009-021792

(51) Int. Cl. H04N 5/335

(52) U.S. Cl. 348/281; 348/273; 348/282; 348/E05.091

(57) ABSTRACT

A semiconductor substrate has an active pixel area comprising a stack of lower electrodes, an intermediate layer of an organic photoelectric conversion material, an upper electrode, a transparent insulating layer and first to third color layers. Disposed outside the active pixel area is a polish stop layer having a high resistance to polishing. In planarizing the first to third color layers, the polishing operation is ended upon reaching the polish stop layer.

### FIELD OF THE INVENTION

The present invention relates to a light/electric power converter having a polish stop layer outside an active pixel area, and a solid state imaging device equipped with this light/electric power converter.

### BACKGROUND OF THE INVENTION

Current solid state imaging devices become to have an ever-smaller light receiving area per one pixel so as to increase the number of pixels. Such downsizing of the light receiving area causes color mixture between adjacent pixels, and the solid state imaging devices need to have a color filter with excellent color separation capability to suppress the color mixture. The color filter is generally formed by a photolithography method or a dry etching method.

The photolithography method, which is compatible with a photolithography process in the semiconductor manufacture, allows for reducing initial investment, and is therefore widely used for forming the color filter. The color filter formation using the photolithography method begins by applying a radiation-sensitive compound containing colorant on a substrate, and drying it there to form a coating layer. This coating layer is cured into a pattern by a radioactive ray irradiated through a mask, and then developed and baked to form first color pixels. The same operation is repeated for second and subsequent color pixels, and an array of color filters is formed on the substrate.

The dry etching method, when compared with the photolithography method, allows for forming thinner color filters in a microscopic pattern. As a conventional patterning method for vapor-deposited films (see, for example, Japanese Patent Laid-open Publication No. 55-146406), the dry etching method can reduce the thickness of a color filter to less than half of the one formed in the photolithography method, and still achieves substantially identical spectroscopic property to this counterpart. There is also disclosed a patterning method that combines the photolithography method and the dry etching method (see, for example, Japanese Patent Laid-open Publication No. 2001-249218).

In the photolithography method and the dry etching method, the color filters need to avoid overlapping between adjacent pixels, or otherwise the color mixture is induced and the color separation capability is lowered. Accordingly, a typical color filter formation process includes a step of planarizing the color filters having been patterned. In the dry etching method, especially, first color filters (first color layer) are firstly patterned, and then color filter materials (colorant compositions) of different colors are applied on the first color layer to form second and subsequent color filters (color layers). Accordingly, the second and subsequent color layers are planarized by a CMP (chemical mechanical planarization) method or an etch back method to the same thickness as the first color layer, so as to arrange the second and subsequent color filters in between the first color filters (see, for example, Japanese Patent Laid-open Publication No. 2006-351786).

Meanwhile, a typical solid state imaging device has a light/electric power converter that is generally a photodiode, a photoconductor or a phototransistor made from an inorganic material. Some of the current light/electric power converters, however, are made from an organic material that offers an easier production process, cost reduction and a larger devise area (see, U.S. Patent Application Publication No. 2005/0195318 A1 corresponding to Japanese Patent Laid-open Publication No. 2005-311315).

FIG. 32 shows a typical light/electric power converter 100 made from an organic material. The light/electric power converter 100 includes a semiconductor substrate 101 at the bottom, lower electrodes 102, a photoelectric conversion area 103, upper electrodes 104, a transparent insulating layer 105 and color filters 106R, 106G, 106B. Of the photoelectric conversion area 103, the portions between the lower electrodes 102 and the upper electrodes 104 work as a light receiving area (photoelectric conversion section). When receiving a light ray through a micro-lens (not shown) and the color filters 106R, 106G and 106B, the photoelectric conversion area 103 of organic material absorbs the incident light ray and generates an exciton. Upon application of voltage between the lower electrodes 102 and the upper electrode 104, the exciton is divided into an electron and a positive hole, which are then attracted to the lower and upper electrodes 102, 104 separately according to the amount of voltage applied. If the upper electrode 104 is charged to a positive potential, for example, the electron is attracted to the upper electrode 104, and the positive hole is attracted to the lower electrode 102. Using an external circuit connected to the lower electrode 102 or the upper electrode 104, an electronic signal can be taken from the light/electric power converter 100. This type of light/electric power converter is mainly used in information read-out devices (solid-state imaging devices). When driven in reverse, the light/electric power converter can work in organic electroluminescent devices (organic EL color displays) or similar devices (see, Japanese Patent Laid-open Publication No. 11-297477 and U.S. Pat. No. 6,552,488 B1 corresponding to Japanese Patent Laid-open Publication No. 2001-126864).

This type of organic light/electric power converter can be produced in the above-mentioned manufacturing method. Namely, each color layer of the light/electric power converter needs to be planarized after the patterning thereof. The organic light/electric power converter, however, has a multilayer structure where the electrodes and the photoelectric conversion layer are stacked on the semiconductor substrate, creating an uneven surface between the semiconductor substrate and the color filters. Accordingly, during a polishing or etching operation of the planarizing step places that puts a heavy load on each layer, the organic photoelectric conversion layer may possibly be detached. In actual practice, the polishing operation and the etching operation are controlled in time to have a desired thickness. However, this time control method does not guarantee a uniform layer thickness of the light/electric power converters, particularly when the speed of the polishing or etching operation fluctuates. The resultant variation in layer thickness may change sensitivity, luminance, dispersion and other characteristics.

### SUMMARY OF THE INVENTION

In view of the foregoing, it is a main object of the present invention to provide a light/electric power converter and a solid state imaging device having color filters precisely adjusted to a given thickness through planarization of their top surfaces.

The other object of the present invention is to provide a light/electric power converter and a solid state imaging device that offer low cost.

In order to achieve the above and other objects, a light/electric power converter according to the present invention includes a structure disposed outside an active pixel area on a substrate. The active pixel area is composed of a plurality of pixels. Each of these pixels includes a lower electrode on the substrate, an intermediate layer of an organic photoelectric conversion material that covers over the lower electrode, an upper electrode on the intermediate layer and a color filter above the upper electrode. The structure has an upper surface that is level with an upper surface of the color filter.

Preferably, the upper surface has a higher resistance to polishing than the color filter. With a multilayer structure, the layer level with the color filters has a higher resistance to polishing.

In a preferable embodiment of the present invention, the intermediate layer extends all over the active pixel area. Similarly, the upper electrode extends all over the active pixel area. Between the upper electrode and the color filter, there is provided a transparent insulating layer that extends all over the active pixel area.

The structure may have a rectangular frame shape for surrounding the active pixel area. The structure is preferably made of silicon oxide, silicon nitride or nitride-oxide silicon. Alternatively, the structure may be made of a conductive material, and connected to the upper electrode.

The structure may be a stack of two or more materials. It is preferred in this instance that the structure is a stack of two or more materials including the same material as the transparent insulating layer. Alternatively, the structure may be a stack of two or more materials including a conductive material.

It is also preferred to provide a drive circuit with the light/electric power converter. In the preferable embodiment, the drive circuit is attached to the substrate to position below the lower electrode and is connected to the lower electrode.

A solid state imaging device according the present invention includes the light/electric power converter having the drive circuit, and activates this drive circuit to read out an electrical charge from the photoelectric conversion material. The drive circuit preferably includes a CCD type or CMOS type signal read-out circuit.

According to the present invention, the structure is provided outside the active pixel area on the substrate. By planarizing the color filters to level with the structure, it is possible to precisely adjust the thickness of the color filter array. Additionally, the structure receives the heavy load of the planarizing steps, and prevents the intermediate layer of organic material from detaching. As a result, the production is improved, and the costs for the light/electric power converter and the solid state imaging device are reduced.

### BRIEF DESCRIPTION OF THE DRAWINGS

The above objects and advantages of the present invention will become more apparent from the following detailed description when read in connection with the accompanying drawings, in which:

FIG. 1 is a cross-sectional view of a solid state imaging device according to the present invention;

FIG. 2 is a flow chart of manufacturing a light/electric power converter;

FIG. 3 is an enlarged cross-sectional view about a semiconductor substrate;

FIG. 4 is a cross-sectional view of the semiconductor substrate with electrode pads formed thereon;

FIG. 5 is a perspective view of the semiconductor substrate with a polish stop layer formed thereon;

FIG. 6A and FIG. 6B are cross-sectional views showing a step of forming an intermediate layer;

FIG. 7 is a cross-sectional view showing a step of forming upper electrodes;

FIG. 8 is a cross-sectional view showing a step of forming a transparent insulating layer;

FIG. 9 is a cross-sectional view of the semiconductor substrate before formation of a color filter array;

FIG. 10 is a flow chart of forming the color filter array;

FIG. 11 is a cross sectional view showing a light shield layer over the transparent insulating layer;

FIG. 12 is a cross sectional view showing a photoresist layer over the light shield layer;

FIG. 13 is a cross sectional view showing the photoresist layer after the patterning of a first color layer region;

FIG. 14 is a cross sectional view showing the light shield layer after the etching of the first color layer region;

FIG. 15 is a cross-sectional view after the removal of the photoresist layer;

FIG. 16 is a cross-sectional view at the formation of the first color layer;

FIG. 17 is a cross-sectional view showing a photoresist layer on the first color layer;

FIG. 18 is a cross-sectional view showing the photoresist layer after the patterning of a second color layer region;

FIG. 19 is a cross-sectional view showing the first color layer after the patterning of the second color layer region;

FIG. 20A and FIG. 20B are cross-section views at before and after the planarization of the first color layer;

FIG. 21 is a cross-sectional view at the formation of the second color layer;

FIG. 22A and FIG. 22B are cross-sectional views showing the first and second color layers after the etching of a third color layer;

FIG. 23A and FIG. 23B are cross-sectional views at before and after the planarization of the second color layer;

FIG. 24A and FIG. 24B are cross-sectional views at before and after the planarization of the third color layer;

FIG. 25A to FIG. 25C are cross-sectional views showing a planarizing step to a transparent insulating layer in a second embodiment;

FIG. 26 is a cross-sectional view at the formation of a color filter array in a third embodiment;

FIG. 27A to FIG. 27C are cross-sectional views showing a polish stop layer, a transparent insulating layer and a color filter array in a fourth embodiment;

FIG. 28A to FIG. 28C are cross-sectional views showing a polish stop layer, upper electrodes and a color filter array in a fifth embodiment;

FIG. 29A and FIG. 29B are cross-sectional views showing a sloping surface on a conductive polish stop layer in a sixth embodiment;

FIG. 30A to FIG. 30C are cross-sectional views showing a planarizing step to a transparent insulating layer on a conductive polish stop layer in a seventh embodiment;

FIG. 31A and FIG. 31B are cross-sectional views showing the formation of a color filter array in a eighth embodiment; and

FIG. 32 is a cross-sectional view of a prior art light/electric power converter.

### DETAILED DESCRIPTION OF THE PREFERRED EMBODIMENTS

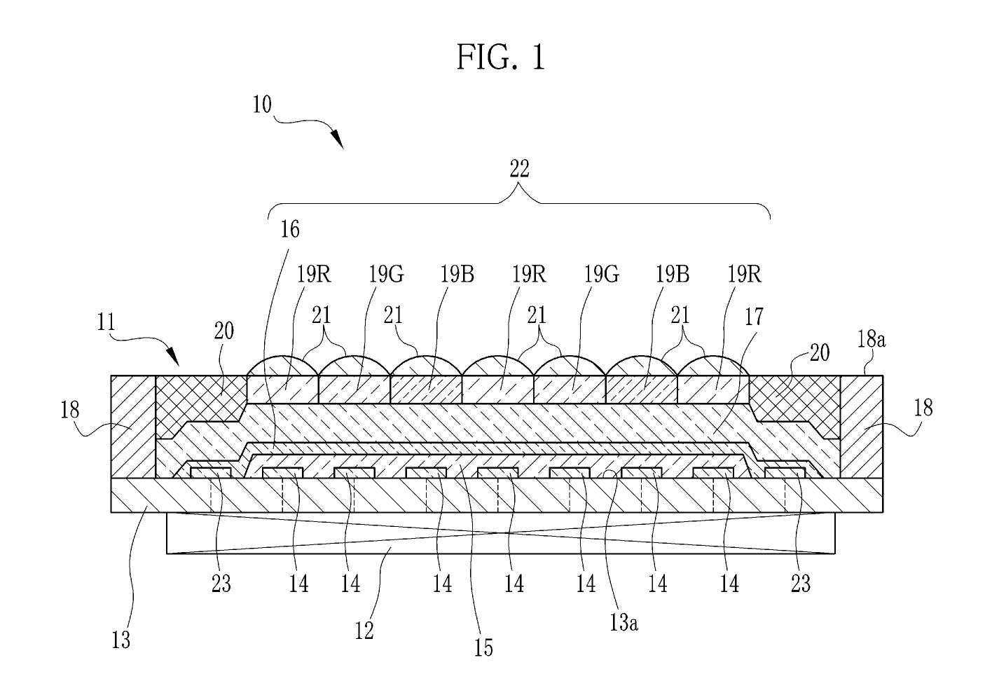

Referring to FIG. 1, a solid state imaging device 10 has a light/electric power converter 11 and a drive circuit 12. The light/electric power converter 11 includes a semiconductor substrate 13 having a top surface 13a as a reference plane, a plurality of lower electrodes 14 on the top surface 13a, an intermediate layer 15 covering the lower electrodes 14, an upper electrode 16 on the intermediate layer 15, a transparent insulating layer 17 covering the upper electrode 16, a polish stop layer (structure) 18 on the top surface 13a, an array of color filters 19R, 19G and 19B, a light shield layer 20 surrounding the color filter array, and an array of micro-lenses 21 on the color filters 19R, 19G and 19B. The overlap of the lower electrode 14, the intermediate layer 15, the upper electrode 16, one of the color filters 19R, 19G and 19B and one of the micro-lenses 21 constitutes a single pixel. These pixels are arranged in a mosaic pattern to form an active pixel area 22.

The color filters 19R, 19G and 19B transmit red light, green and blue light respectively. A plurality of upper electrode pads 23 are provided at certain intervals from the lower electrodes 14 on the top surface 13a. These upper electrode pads 23 are in contact with upper electrode 16.

The intermediate layer 15 is made from an organic photoelectric conversion material, and the portions between the lower electrodes 14 and the upper electrode 16 function as a light receiving area. When a ray of light passes through the micro-lens 21, one of the color filters 19R, 19G and 19B and the transparent insulating layer 17 to reach the intermediate layer 15, the organic photoelectric conversion material absorbs this incident light ray and generates an exciton. Upon application of voltage between the lower electrode 14 and the upper electrode 16, the exciton is divided into an electron and a positive hole, which are then attracted separately to the lower electrode 14 and the upper electrode 16 according to the amount of voltage applied.

The drive circuit 12 is connected to the lower electrodes 14 and the upper electrode 16. Having a CCD type or CMOS type read-out section, the drive circuit 12 transmits electric charges between the lower electrodes 14 and the upper electrodes 16 to the outside. In FIG. 1, the drive circuit 12 is located on the under surface of the semiconductor substrate 13, but it can be located anywhere below the electrodes. For example, in the manner of signal read-out regions 26 in FIG. 3, the drive circuit 12 may be located higher than the semiconductor substrate 13.

The polish stop layer 18 is located outside the active pixel area 22, and has a substantially rectangular shape to surround the active pixel area 22. The polish stop layer 18 may, however, have any shape insofar as it follows at least a part of the circumference of the active pixel area 22. The polish stop layer 18 is made of a material having a higher resistance to polishing and etching than the color filters 19R, 19G and 19B, such as a metallic material, a metal oxide or a metal nitride, and has an upper surface 18a level with the color filters 19R, 19G and 19B.

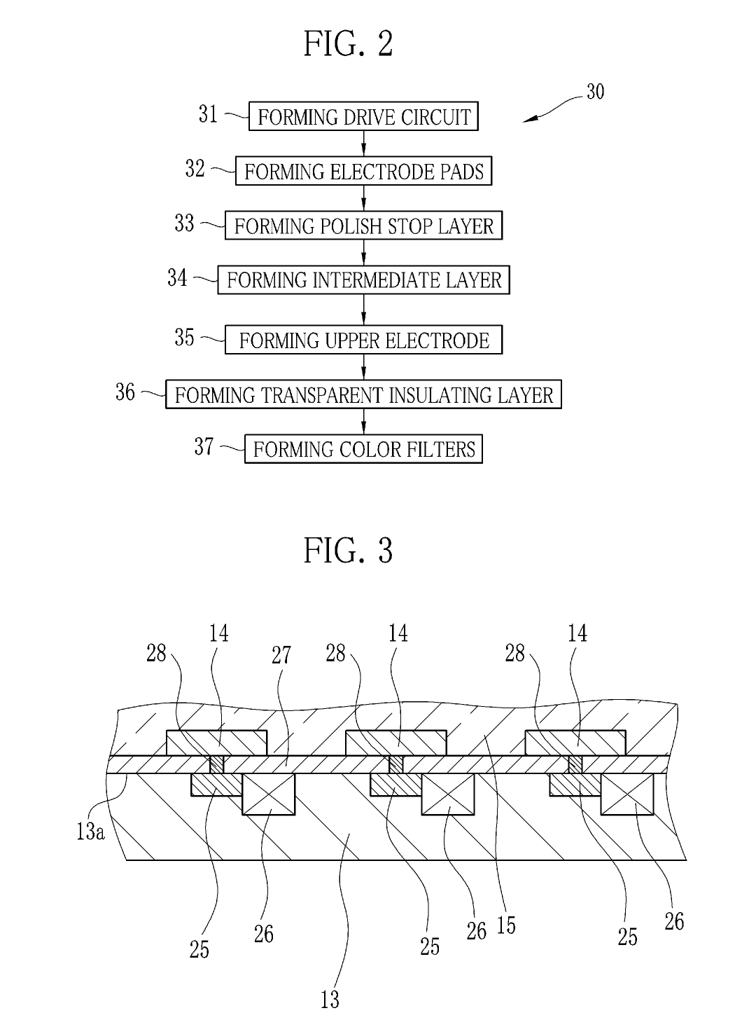

The light/electric power converter 11 is assembled in a light/electric power converter fabrication procedure 30. As shown in FIG. 2, the fabrication procedure 30 includes a drive circuit forming process 31, an electrode pad forming process 32, a polish stop layer forming process 33, an intermediate layer forming process 34, an upper electrode forming process 35, a transparent insulating layer forming process 36, and a color filter forming process 37.

In practice, a micro-lens forming process follows the fabrication procedure 30. This micro-lens forming process can, however, be omitted when the light/electric power converter 11 is used in the organic electroluminescent devices.

[Drive Circuit Forming Process]

In the drive circuit forming process 31, the drive circuit 12 is formed underneath the semiconductor substrate 13. The drive circuit 12 is formed on the substrate 13 by a common fabrication technique for semiconductor integrated circuits. Specifically, the semiconductor substrate 13 is composed of an n-type silicon substrate and a p-type well layer on the n-type silicon substrate. Alternatively, a p-type silicon substrate may be used in place of the n-type silicon substrate. Additionally, the substrate is not necessarily the semiconductor substrate, but may be a glass substrate, a quartz substrate or a similar substrate, insofar as it can incorporate an electric circuit inside or on the top surface.

As shown in FIG. 3, the semiconductor substrate 13 contains, at the positions corresponding to the lower electrodes 14, a plurality of charge storage regions 25 of n-type impurities for storing the electric charges on the lower electrodes 14, and a plurality of signal read-out regions 26 for converting these signal charges into voltage signals. The regions 25, 26 are covered with an insulating film 27 that extends all over the top surface 13a of the semiconductor substrate 13. The charge storage regions 25 are electrically connected to the lower electrodes 14 by means of conductive plugs 28 that penetrate the insulating film 27. Through these plugs 28, the electrical charges on the lower electrodes 14 are transmitted to the charge storage regions 25. The signal read-out region 26 is either a combination circuit of a CCD and an amplifier, or a CMOS circuit. The insulating film 27 holds, in addition to the plugs 28, a light-shielding film for separating the charge storage regions 25 and the signal read-out regions 26 from the incident light, wirings for driving the signal read-out regions 26, and other elements.

[Electrode Pad Forming Process]

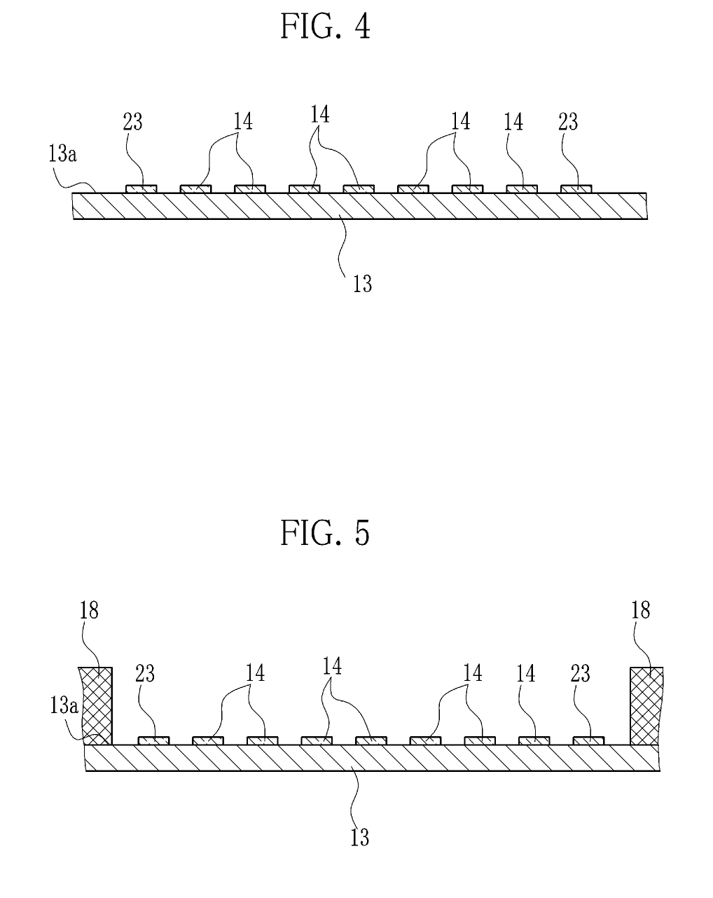

The electrode pad forming process 32 follows the drive circuit forming process 31. As shown in FIG. 4, the electrode pad forming process 32 uses a PVD or CVD method to form the lower electrodes 14 and the upper electrode pads 23 on the top surface 13a of the semiconductor substrate 13. For finer patterning of the lower electrodes 14 and the upper electrode pads 23, it may be possible to form an electrode layer over the semiconductor substrate 13 using the PVD or CVD method, and then remove the electrode layer partially by a dry etching method to create the lower electrodes 14 and the upper electrode pads 23.

The lower electrodes 14 and the upper electrode pads 23 are preferably made from a common wiring material for semiconductor integrated circuits, Ag, Pt, Au or a similar noble metal, or a transparent conductive film such as indium-tin-oxide (ITO). A preferable material among them is Al, Ti, Mo, Ta, W or an alloy or a silicide or a nitride of these, or polycrystalline silicon, which all assure a precise patterning by dry etching.

[Polish Stop Layer Forming Process]

The electrode pad forming process 32 is followed by the polish stop layer forming process 33. As shown in FIG. 5, the polish stop layer forming process 33 uses the PVD or CVD method to form the polish stop layer 18 outside the active pixel area 22 on the top surface 13a, or a reference plane, of the semiconductor substrate 13.

Although the polish stop layer 18 is formed into a rectangular frame shape, it may have only three sides, forming an open-ended rectangle. The polish stop layer 18 in this process has an extra thickness to be reduced to the same level as the color filters 19R, 19G and 19B by a polishing or etching operation in the subsequent planarizing step. Preferably, the polish stop layer 18 is made of an inorganic material having a resistance to CMP and dry-etching performed in the planarizing step. In particular, the polish stop layer 18 is preferably made either from silicon oxide, silicon nitride, nitride-oxide silicon or a similar insulating material, which can be easily patterned by a common semiconductor microfabrication technique, such as dry-etching.

[Intermediate Layer Forming Process]

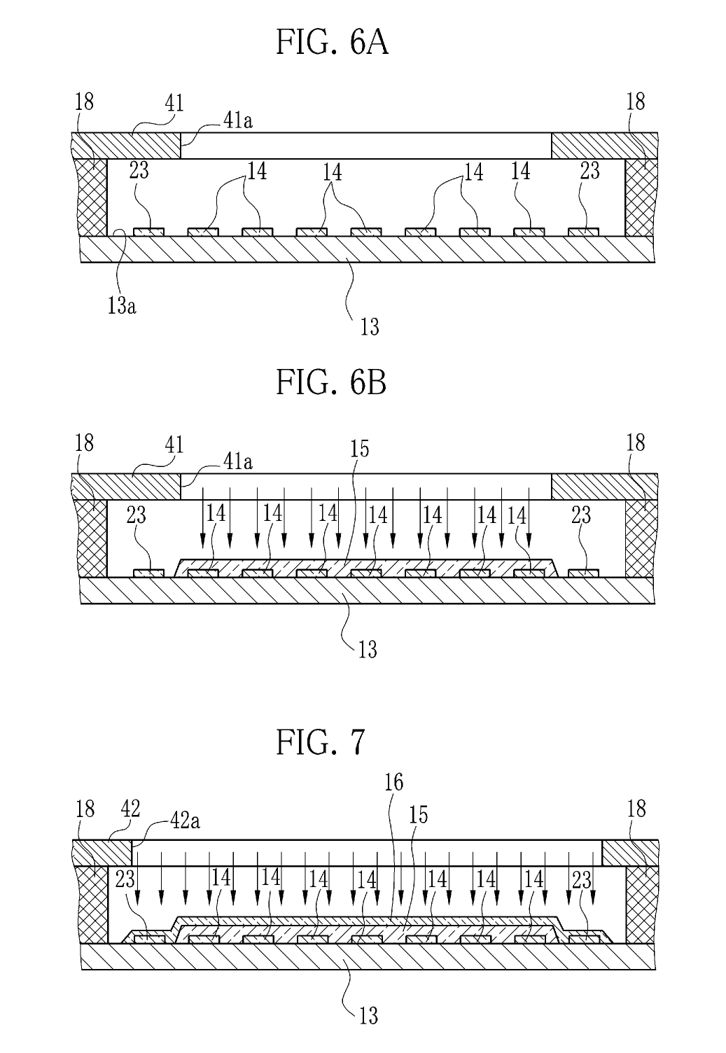

The polish stop layer forming process 33 is followed by the intermediate layer forming process 34. In this process, as shown in FIG. 6A and FIG. 6B, a metal mask 41 is placed on the polish stop layer 18 (see, FIG. 6A), and an organic photoelectric conversion material is deposited by vapor deposition to form the intermediate layer 15 over the lower electrodes 14 (see, FIG. 6B). The metal mask 41 covers the polish stop layer 18 and the upper electrode pads 23 while exposing the lower electrodes 14 through an opening 41a in the center. The metal mask 41 of this configuration allows for spreading the intermediate layer 15 over the lower electrodes 14. As a result, the intermediate layer 15 extends all over the active pixel area 22, without interruption between the pixels.

The intermediate layer 15 is a stack or a combination of a photoelectric conversion section, an electron transport section, a positive hole transport section, an electron blocking section, a positive hole blocking section, an anti-crystallization section, and an interlayer contact assisting section. The photoelectric conversion section contains an organic photoelectric conversion material, and preferably contains organic p-type compounds and/or organic n-type compounds. As described in detail in U.S. Patent Application Publication No. 2009/0223566 (corresponding to Japanese Patent Application No. 2008-058406), the intermediate layer 15 is preferably made by depositing a compound of, for example, a chemical formula 1 below as the positive hole transport section (thickness of 0.1 μm), and by codepositing a compound of a chemical formula 2 below and C₆₀ in a volume ratio of 1:3 as the photoelectric conversion section (thickness of 0.4 μm). The degree of vacuum in both of these depositing operations is preferably 1×10⁻⁴ Pa or below. This configuration of the intermediate layer 15 is suitable for transporting the positive holes to the lower electrodes 14 and the electrons to the upper electrode 16.

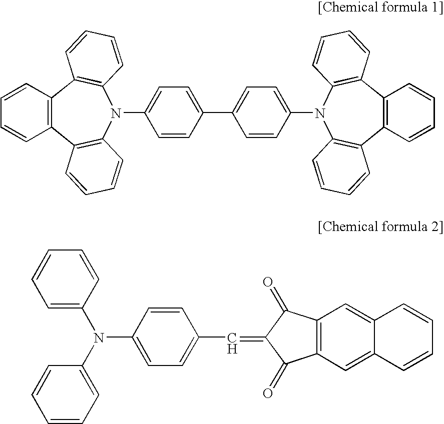

[Upper Electrode Forming Process]

The upper electrode forming process 35 follows the intermediate layer forming process 34. In this process, as shown in FIG. 7, the upper electrode 16 is formed by sputtering with use of a metal mask 42 placed on the polish stop layer 18. The metal mask 42 covers the polish stop layer 18 while exposing the intermediate layer 15 and the upper electrode pads 23 through an opening 42a in the center. The metal mask 42 of this configuration allows for spreading the upper electrode 16 over the intermediate layer 15 and the upper electrode pads 23. As a result, the upper electrode 16 extends all over the active pixel area 22, without interruption between the pixels. The upper electrode 16 is connected to the drive circuit 12 by means of the upper electrode pads 23.

To facilitate the passage of light rays, the upper electrode 16 is preferably a transparent conductive film. The upper electrode 16 is preferably made of a transparent conductive material. For example, the upper electrode 16 may be formed by high-frequency magnetron sputtering to form an ITO film on the intermediate layer 15 in an atmosphere of Ar gas and O₂ gas under a degree of vacuum of 1 Pa.

[Transparent Insulating Layer Forming Process]

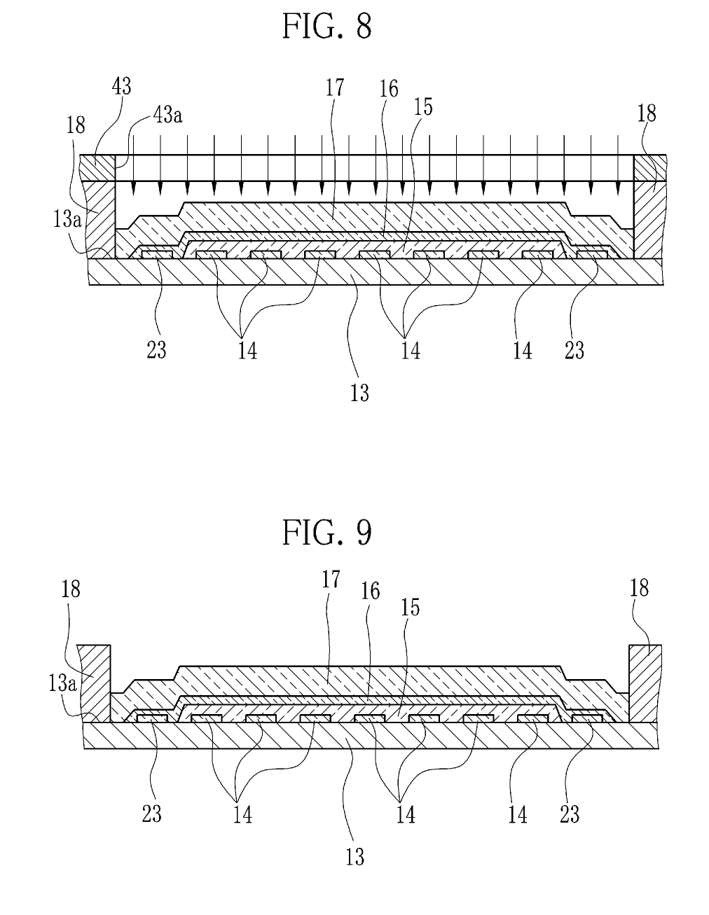

The upper electrode forming process 35 is followed by the transparent insulating layer forming process 36. As shown in FIG. 8, with a metal mask 43 placed on the polish stop layer 18, the transparent insulating layer 17 is formed by predetermined method and material. In particular, the transparent insulating layer 17 is preferably a single or multiple layer of aluminum oxide, silicon oxide, silicon nitride, nitride-oxide silicon or the like formed by a PVD method such as sputtering, a plasma CVD method, a catalytic CVD method or anatomic layer deposition (ALD) method, so that it can seal the organic EL element and the organic photoelectric conversion element which deteriorate rapidly upon exposure to air. For example, the transparent insulating layer 17 may be formed by high-frequency magnetron sputtering of the aluminum oxide in an atmosphere of Ar gas and O₂ gas under a degree of vacuum of 1 Pa.

The metal mask 43 covers the polish stop layer 18 and exposes the upper electrode 16 through an opening 43a in the center. This opening 43a has substantially the same size as an aperture of the polish stop layer 18. The opening 43a in this size allows for spreading the transparent insulating layer 17 fully on the upper electrode 16. As a result, the transparent insulating layer 17 extends all over the active pixel area 22, without interruption between the pixels.

To prevent ingress of deteriorating substances (i.e., moisture and the like) for the light/electric power converter 11, it is preferred to perform the intermediate layer forming process 34, the upper electrode forming process 35 and the transparent insulating layer forming process 36 successively in a vacuum or in an inert gas, such as Ar gas or N₂ gas, while keeping the semiconductor substrate 13 from air. It is particularly preferable to use an organic EL manufacturing apparatus which includes a vacuum deposition device for forming the intermediate layer 15 of organic material, a first sputtering device for forming the upper electrode 16 of ITO, a second sputtering device for forming the transparent insulating layer 17 and several CVD devices which are connected directly to a cluster-type vacuum transport chamber maintained at a pressure of 1×10⁻⁴ Pa or below.

[Outline of Color Filter Forming Process]

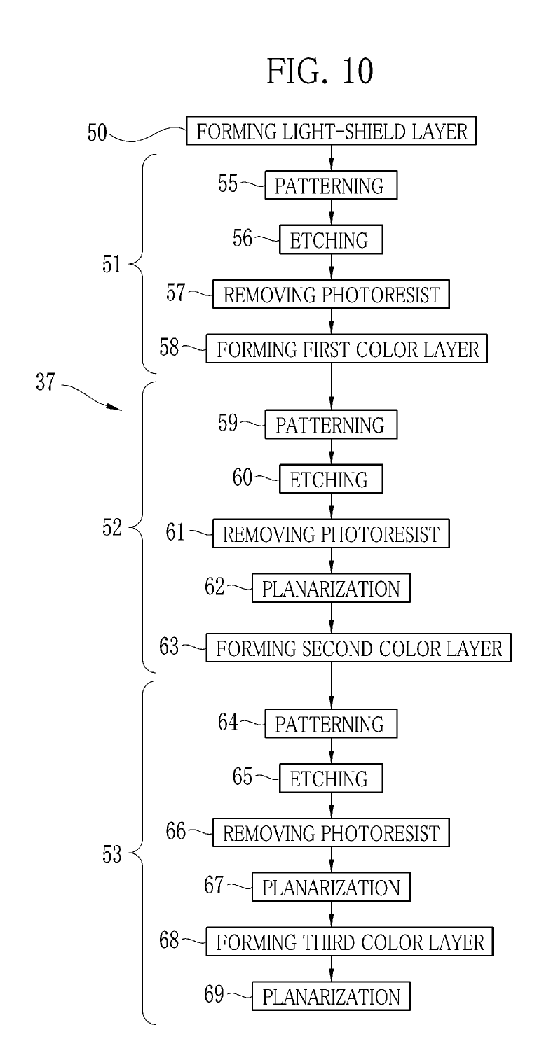

The metal mask 43 is removed after the formation of the transparent insulating layer 17 (as shown in FIG. 9), and the color filter forming process 37 is conducted. As shown in FIG. 10, the color filter forming process 37 includes a light shield layer forming step 50, a first color filter forming step 51, a second color filter forming step 52 and a third color filter forming step 53. The first to third colors, in this embodiment, correspond to any of red, green and blue.

The first to third color filter forming steps 51-53 respectively include patterning steps 55, 59, 64, etching steps 56, 60, 65, photoresist removing steps 57, 61, 66, color layer forming steps 58, 63, 68 and planarizing steps 62, 67, 69. The first color filter forming step 51 includes no planarizing step. By contrast, the third color filter forming step 53 includes two planarizing steps 67, 69. Hereinafter, process steps in the color filter forming process 37 are described in detail.

[Light Shield Layer Forming Step]

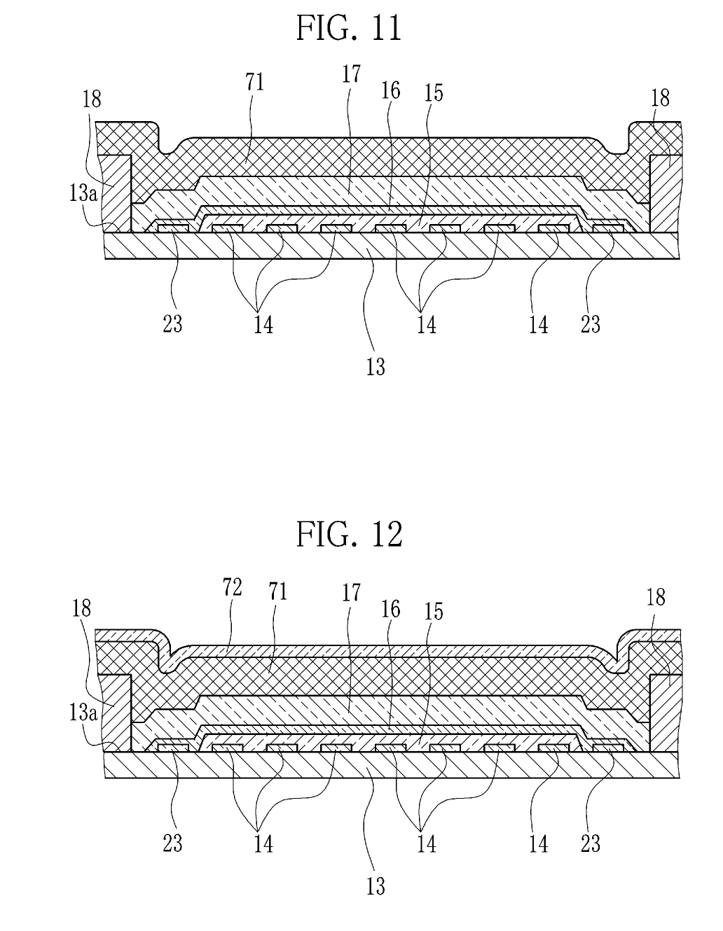

The color filter forming process 37 begins by the light shield layer forming step 50. As shown in FIG. 11, the light shield layer forming step 50 uses a spin coater method to apply a black colorant composition over the entire surfaces of the polish stop layer 18 and the transparent insulating layer 17. In particular, the black colorant composition preferably contains dispersed particles of titanium black or carbon black. The coating layer of black colorant composition is then heat-cured for five to ten minutes at a temperature of between 200° C. and 250° C. using a hot plate so as to form a light shield layer (black color layer) 71. This heating operation may be done in parallel with or in succession to a drying operation of the coating layer.

[First Color Filter Forming Step]

After the light shield layer forming step 50, the first to third color filter forming steps 51-53 are performed in succession.

[Patterning of I-Ray Photoresist]

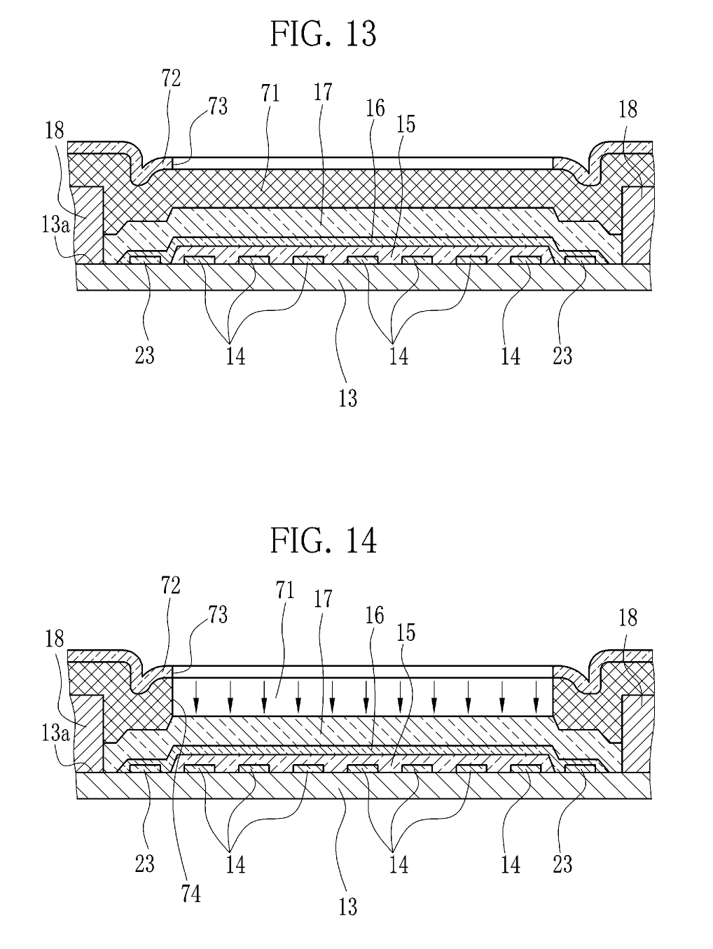

As shown in FIG. 12, the first color filter forming step 51 uses the spin coater method to apply a positive photoresist (for example, FHi622BC (product name) from FUJIFILM electronic materials Co., Ltd.) on the light shield layer 71. Then, using the hot plate, the photoresist is baked (pre-bake) to a photoresist layer 72. Specifically, the photoresist is baked for 60 seconds at a temperature of between 80° C. and 100° C. This photoresist layer 72 is exposed through a photo mask which defines the active pixel area 22 where the color filters 19R, 19G and 19B are arranged. The exposing source may be, for example, an I-ray (wavelength 365 nm) stepper. Thereafter, the photoresist layer 72 is heated (Post exposure bake: PEB) with the hot plate for 90 seconds at a temperature of between 100° C. and 120° C. After puddle development using a liquid developer, the photoresist layer 72 is baked (post-bake) with the hot plate. Then, the photoresist in the exposed area is removed (patterning step 55). FIG. 13 shows the photoresist layer 72 created by removing the photoresist in the exposed area. A reference numeral 73 in the drawing designates an etching hole after the removal of the photoresist.

The photoresist may be any conventional positive photoresist. More specifically, the positive photoresist may be a positive photopolymer that is sensitive to ultraviolet rays (G-ray, I-ray), far-ultraviolet rays, and electron rays including KrF, Arf and other excimer lasers.

The liquid developer may be any conventional developer insofar as it can dissolve the exposed positive photoresist and the uncured negative photoresist without affecting the light shield layer 71. An example of the liquid developer is a combination of organic solvents or an alkaline aqueous solution.

[Etching Step]

In the subsequent etching step 56, the light shield layer 71 is dry-etched using the photoresist layer 72 as a mask. This step is performed with a dry-etching apparatus, such as a reactive ion etching (RIE) apparatus. As well known, the RIE apparatus may be of several types, such as a parallel plate type, a capacitively-coupled type and an electron cyclotron resonance type, and performs the dry-etching using a radio frequency discharge. The light shield layer 71 is removed from the active pixel area 22 by dry etching. FIG. 14 shows the light shield layer 71 after the etching step 56. A reference numeral 74 in the drawing designates an etching hole formed by the etching step 56.

Specifically, the etching step 56 includes a first dry-etching operation to create the etching hole, and a second dry-etching operation to eliminate residues.

[First Dry-Etching Operation]

To shape a rectangular etching hole in the light shield layer 71, the first dry-etching operation is preferably performed with a first etching gas containing at least one fluorine-based gas and an O₂ gas. This first etching gas is introduced into a chamber enclosing a flat electrode (cathode), and the semiconductor substrate 13 placed thereon. Then, a radio frequency voltage is applied between the flat electrode and an opposite electrode to induce a cathode effect to etch the rectangular opening in the light shield layer 71. A favorable fluorine-based gas for the first etching gas is given by Expression (I) below, wherein the variable “n” represents one of 1-6, the variable “m” represents one of 0-13 and the variable “l” represents one of 1-14.

CₙHₘF₁ Expression (I)

The fluorine-based gases given by Expression (I) may be any of CF₄, C₂F₆, C₃F₈, C₂F₄, C₄F₆, C₄F₈, C_{S}F_{B} and CHF₃. These gases may be used alone or in combination. To keep the shape of the rectangular etching hole, at least one of CF₄, C₄F₆, C₄F₈ and CHF₃ may be used. Preferably, one of or a mixed gas of CF₄ and C₄F₆ is used, and yet more preferably the mixed gas of CF₄ and C₄F₆ is used.

Preferably, in order to stabilize etching plasma and keep the verticality of the etching hole, the first etching gas further contains, along with the fluorine-based gas and the O₂ gas, at least one of noble gases including He, Ne, Ar, Kr and Xe, halogen-based gases (for example, CCl₄, CClF₃, AlF₃, AlCl₃) containing a halogen atom, such as chlorine, fluorine or bromine, N₂, CO and CO₂. More preferably, the first etching gas contains at least one of Ar, He, Kr, N₂ and Xe, and most preferably contains one of He, Ar and Xe. The first etching gas may, however, contain only the fluorine-based gas and the O₂ gas, when it can stabilize the etching plasma and keep the verticality of the etching hole.

In the first etching operation, it is preferred to estimate an etching process time by: (1) calculating an etching rate of the light shield layer 71 in the first etching operation, and (2) calculating the process time to etch the light shield layer 71 of a given thickness, based on the etching rate of the procedure (1).

The aforesaid etching rate may be calculated from, for example, the correlation of an etching time and the remaining layer thickness. A preferable etching process time in the present invention is 10 minutes or less, and more preferably 7 minutes or less.

[Second Dry-Etching Operation]

The second dry-etching operation to eliminate residues is conducted with a second etching gas containing the O₂ gas. This operation allows for eliminating the alteration surface of the photoresist layer 72 and the residues in the etching hole of the light shield layer 71, without changing the shape of the rectangular etching hole.

In view of the stability of etching plasma, the second etching gas preferably contains, along with the O₂ gas, at least one of He gas, Ne gas, Ar gas, Kr gas, Xe gas and N₂ gas. The mixing rate of this additive gas and the O₂ gas (Ar or another gas/O₂ gas) is preferably 40/1 or less on a flow rate basis, and yet preferably 20/1 or less, and most preferably 10/1 or less. Additionally, the second etching gas may contain 5% or less of fluorocarbon gas to improve the residue eliminating performance.

The additive gas preferably contains one of He, Ar and Xe gases. The additive gas may, however, be omitted when the O₂ gas can provide sufficient stability of etching plasma.

It is preferred to last the second dry-etching operation for a previously estimated etching process time. To keep the rectangular shape of the etching hole, the etching process time for the second dry-etching operation may be 3 to 10 seconds preferably, and 4 to 8 seconds more preferably.

[Photoresist Removing Step]

The photoresist removing step 57 follows the etching step 56. This step uses a solvent or a photoresist removing liquid to remove the photoresist layer 72 remaining on the light shield layer 71. Alternatively, the second dry-etching operation may be extended to remove the photoresist layer 72. Although the extension of the second dry-etching operation promotes an asking effect that may possibly cause plasma damage to the uppermost surface of the light shield layer 71, the photoresist layer 72 can be removed without reducing the thickness of the light shield layer 71.

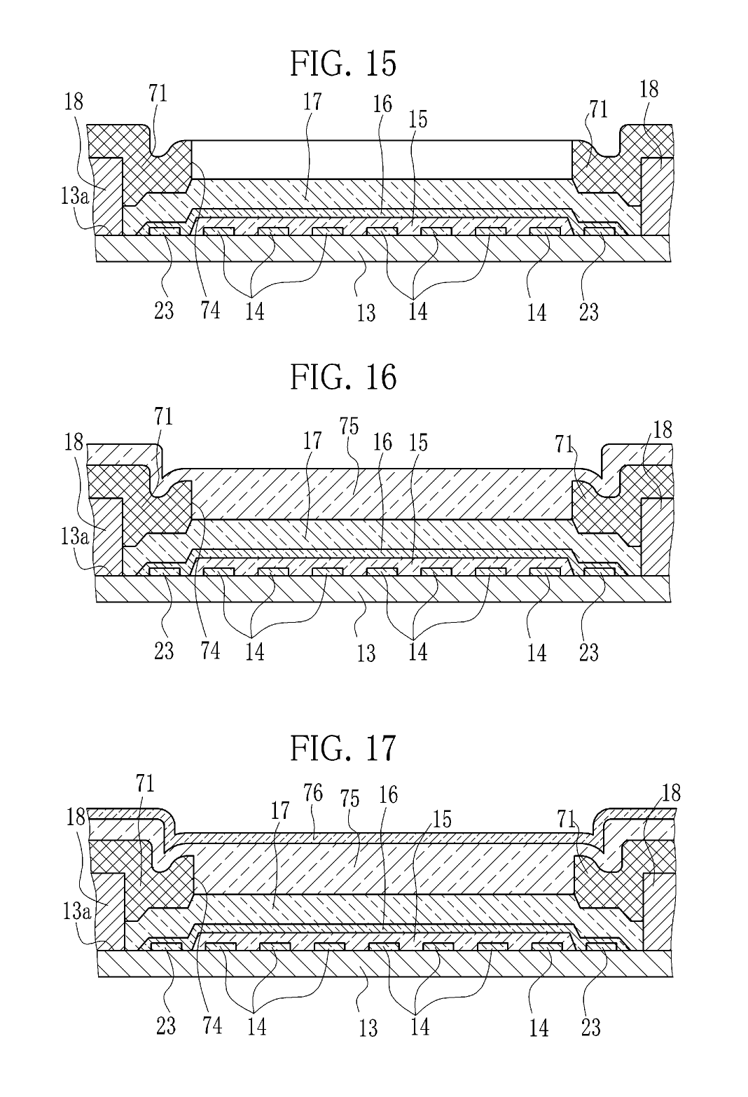

The photoresist removing step 57 may include a baking operation, after the removal of the photoresist layer 72, to draw moisture and solvent. The cross-section after the removal of the photoresist is shown in FIG. 15.

Preferably, the photoresist removing step 57 includes a wetting operation for applying a release agent or a solvent on the photoresist layer 72 to put it in a removable condition, and a rinsing operation for removing the photoresist layer 72 with use of rinse water. An exemplary wetting operation is puddle developing which applies the removing liquid or the solvent at least on the photoresist layer 72 and holds it there for a given time. Although not particularly limited, the time to hold the removing liquid or the solvent is preferably between several tens of seconds and a few minutes.

The rinsing operation is conducted using, for example, a spray nozzle or a shower nozzle that injects the rinse water to wash off the photoresist layer 72. The rinse water is preferably purified water. An exemplary nozzle is a fixed nozzle having an injection area to cover the whole substrate, or a variable nozzle having a variable injection area. With the variable nozzle, the photoresist layer 72 can be washed off effectively by moving the injection area between the center and the edge of the substrate two or more times.

A typical removing liquid contains an organic solvent, and a preferable removing liquid for the present invention further contains an inorganic solvent. The organic solvent may be any of hydrocarbon compounds, halogenated hydrocarbon compounds, alcohol compounds, ether or acetal compounds, ketone or aldehyde compounds, ester compounds, polyalcohol compounds, carboxylic acid or carboxylic acid anhydride compounds, phenol compounds, nitrogen-containing compounds, sulfur-containing compounds and fluorine-containing compounds. It is preferred to use the removing liquid containing the nitrogen-containing compound, and especially, the removing liquid containing both cyclic and acyclic nitrogen-containing compounds is preferred.

The acyclic nitrogen-containing compound preferably has a hydroxyl group, which may be any of, for example, monoisopropanolamine, diisopropanolamine, triisopropanolamine, N-ethyl ethanolamine, N,N-dibutyl ethanolamine, N-butyl ethanolamine, monoethanolamine, diethanolamine and triethanolamine. Preferable among these is monoethanolamine, diethanolamine or triethanolamine, and yet preferable is monoethanolamine (H₂NCH₂CH₂OH).

The cyclic nitrogen-containing compound may be any of isoquinoline, imidazole, N-ethylmorpholine, epsilon-caprolactam, quinoline, 1,3-Dimethyl-2-imidazolidinone, alpha-picoline, beta-picoline, gamma-picoline, 2-pipecoline, 3-pipecoline, 4-pipecoline, piperazine, piperidine, pyrazine, pyridine, pyrrolidine, n-methyl-2-pyrrolidone, N-phenylmorpholine, 2,4-lutidine and 2,6-lutidine. Preferable among these is n-methyl-2-pyrrolidone or N-ethylmorpholine, and yet preferable is n-methyl-2-pyrrolidone (NMP).

In summary, a preferable removing liquid contains at least one of monoethanolamine, diethanolamine and triethanolamine as the acyclic nitrogen-containing compound, and contains at least one of n-methyl-2-pyrrolidone and N-ethylmorpholine as the cyclic nitrogen-containing compound. More preferably, the removing liquid contains monoethanolamine and n-methyl-2-pyrrolidone. The content of the acyclic nitrogen-containing compound to 100 parts by weight of the removing liquid is preferably between 9 and 11 parts by weight, and the content of the cyclic nitrogen-containing compound is preferably between 65 and 70 parts by weight. It is further preferred to dilute the mixture of the cyclic and acyclic nitrogen-containing compounds with purified water.

The photoresist removing step 57 needs only to remove the photoresist layer 72 on the color layers, and there is no need to completely remove the etching products on the side walls of the color layers. Preferably, the photoresist removing step 57 includes a post-baking operation to draw moisture.

[First Color Layer Forming Step]

The photoresist removing step 57 is followed by the color layer forming step 58. As shown in FIG. 16, formed in this step 58 is a first color layer 75 (for example, red color layer) that covers over the light shield layer 71 and fills the etching hole 74. Similar to the light shield layer forming step 50, the spin coater is introduced to apply a color layer composition. The coating layer is then post-baked to the first color layer 75 using the hot plate. To facilitate a subsequent polishing or planarizing operation, the first color layer 75 in this step 58 needs to be taller than the polish stop layer 18. Now, the first color layer 75 is completed, and the first color filter forming step 51 is finished.

[Second Color Filter Forming Step]

The first color filter forming step 51 is followed by the second color filter forming step 52. The second color filter forming step 52 includes a patterning step 59, an etching step 60, a photoresist removing step 61, a planarizing step 62 and a second color layer forming step 63.

[Patterning Step]

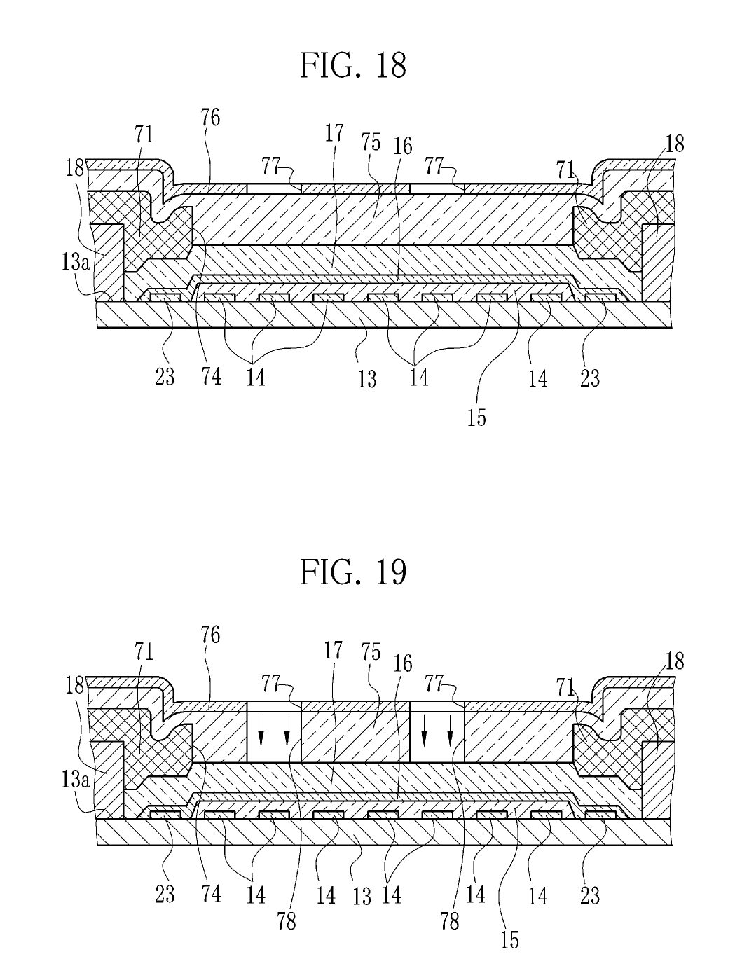

The patterning step 59 begins by applying a positive photoresist over the entire first color layer 75 using the spin coater, and pre-baking the coating layer to a photoresist layer 76 (see, FIG. 17). The photoresist layer 76 is exposed to the I-ray stepper to form a pattern for a second color layer 79 (for example, blue color; see, FIG. 21), and the photoresist is removed. The photoresist layer 76 after the patterning step 59 is shown in FIG. 18, where a reference numeral 77 designates the etching holes being patterned in the photoresist layer 76. This procedure is substantially identical to the patterning step 55.

[Etching Step]

In the etching step 60, the first color layer 75 is etched to form the pattern for the second color layer 79, using the photoresist layer 76 as a mask. To form rectangular pixel patterns in the first color layer 75, the etching step 60 preferably includes two operation steps; a first dry-etching operation to create etching holes using the first etching gas containing a fluorine-based gas and an O₂ gas, and a second dry-etching operation to eliminate residues using the second etching gas containing an N₂ gas and an O₂ gas. The etching holes in the first color layer 75 are shown by numerals 78 in FIG. 19.

[Etching Process Time]

In the first dry-etching operation step, it is preferred to estimate an etching process time by: (1) calculating an etching rate of the first color layer 75, and (2) calculating the process time to etch the first color layer 75 of a given thickness, based on the etching rate of the procedure (1). The etching rate may be calculated from, for example, the correlation of an etching time and the remaining layer thickness. A preferable etching process time is 10 minutes or less, and more preferably 7 minutes or less.

[Photoresist Removing Step]

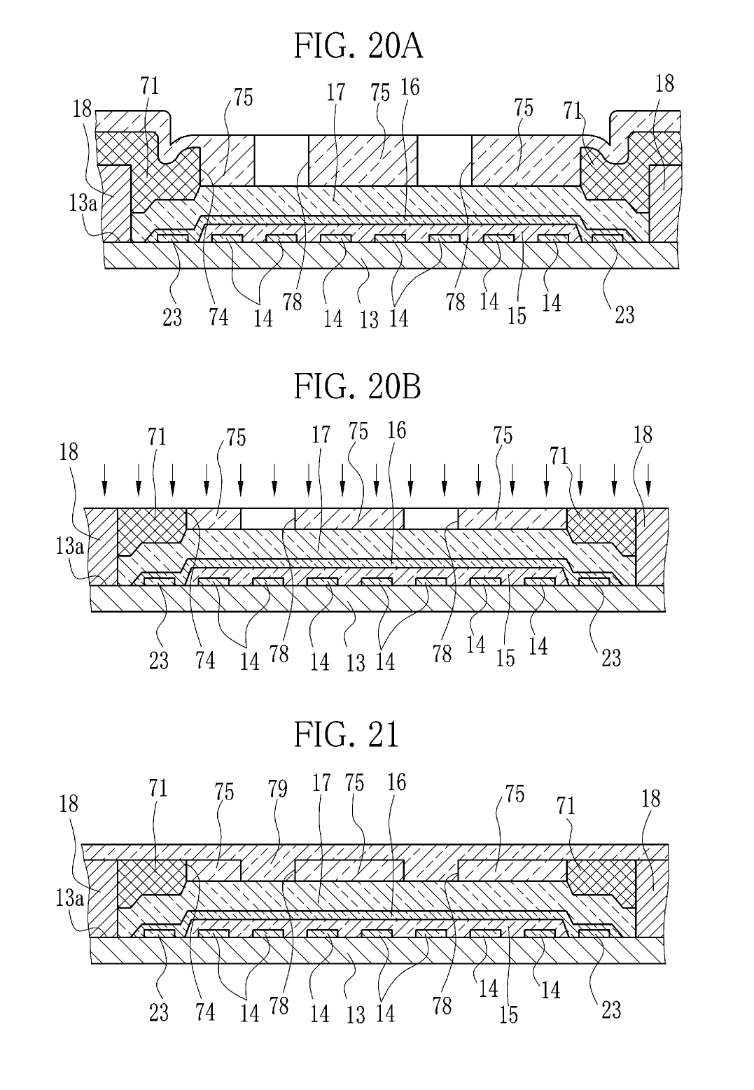

The photoresist removing step 61, as shown in FIG. 20A, removes the photoresist layer 76. The operations, conditions, solvent or removing liquid in this removing step 61 are identical to the photoresist removing step 57.

[Planarizing Step]

The planarizing step 62 uses a CMP machine to polish and planarize the first color layer 75 and the light shield layer 71 until the polish stop layer 18 appears (see, FIG. 20B). Once it appears, the polish stop layer 18 that has a higher resistance than the first color layer 75 retards the polishing rate, allowing for detecting a polishing end point. This facilitates leveling the first color layer 75 with the polish stop layer 18.

[Polishing Conditions]

An exemplary abrasive is slurry having silica particle dispersion, and an exemplary polishing machine has an abrasive cloth and meets the following conditions; slurry flow rate: 100-250 cm³ min⁻¹, wafer pressure: 0.2-5.0 psi, retainer ring pressure: 1.0-2.5 psi. By controlling the rotation of the abrasive cloth to about 30-100 rpm, the color filter can be made with few micro-scratches. The first color layer 75 after the polishing is cleaned with purified water. Then, the first color layer 75 is post-baked to draw moisture.

[Second Color Layer Forming Step]

The second color layer forming step 63 follows the planarizing step 62. As shown in FIG. 21, formed in this step 63 is a second color layer 79 (for example, blue color layer) that covers over the light shield layer 71 and the first color layer 75 and fills the etching hole 78. Similar to the first color forming step, the spin coater is introduced to apply a color layer composition. This coating layer is then post-baked to the second color layer 79 using the hot plate.

[Third Color Filter Forming Step]

The second color filter forming step 52 is followed by the third color filter forming step 53, which includes a patterning step 64, an etching step 65, a photoresist removing step 66, a first planarizing step 67, a color layer forming step 68 and a second planarizing step 69.

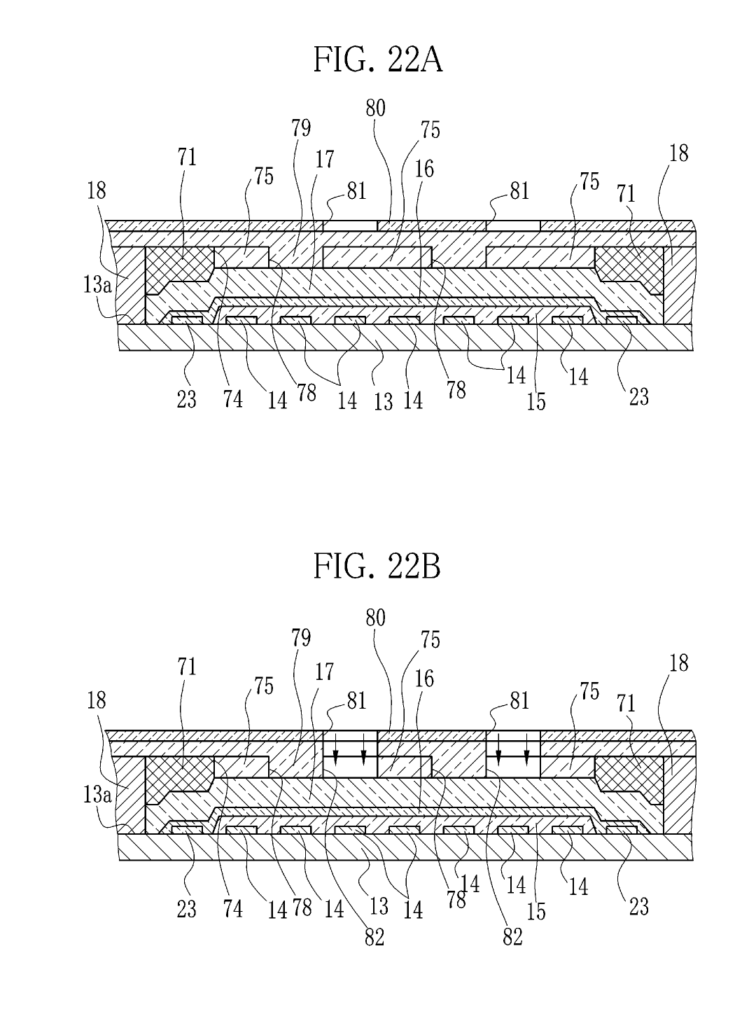

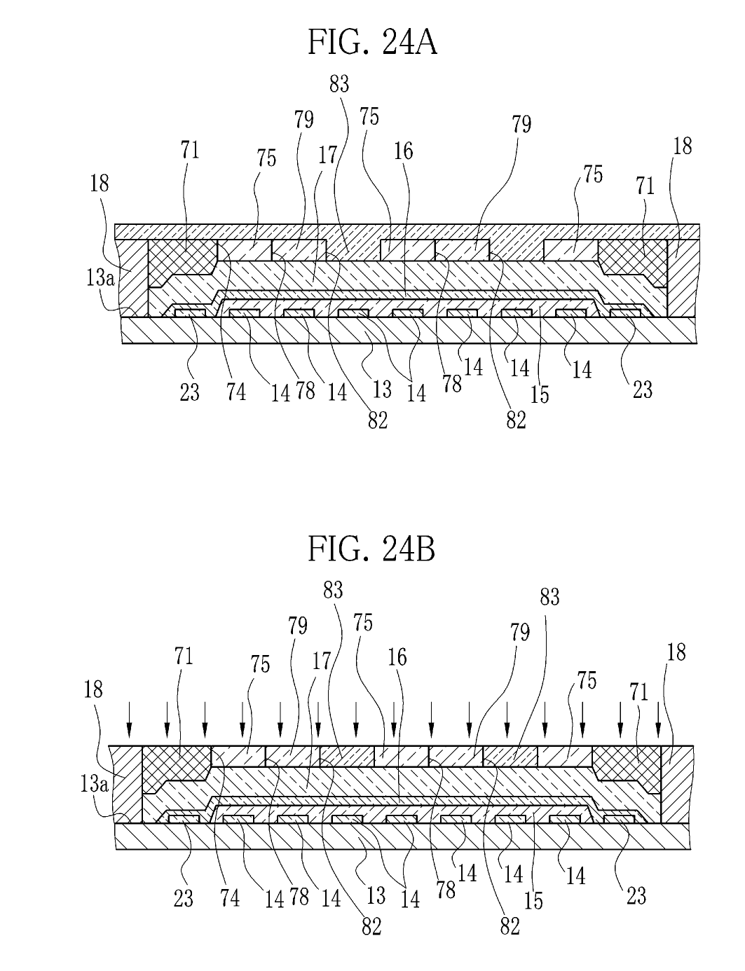

The patterning step 64 begins by applying a positive photoresist over the entire second color layer 79 using the spin coater. This coating layer is pre-baked to a photoresist layer 80. The photoresist layer 80 is then exposed to the I-ray stepper to form a pattern for a third color layer 83 (for example, green color; see, FIG. 24), and the photoresist is removed. The photoresist layer 80 after the patterning step 64 is shown in FIG. 22A, where a reference numeral 81 designates the etching holes being patterned in the photoresist layer 80. This procedure is substantially identical to the patterning step 55.

In the etching step 65, the first and second color layers 75, 79 are etched to form the pattern for the third color layer 83, using the photoresist layer 80 as a mask. A reference numeral 82 in FIG. 22B designates the etching holes in the first and second color layers 75, 79. The operations and conditions for the etching step 65 are identical to the etching step 60.

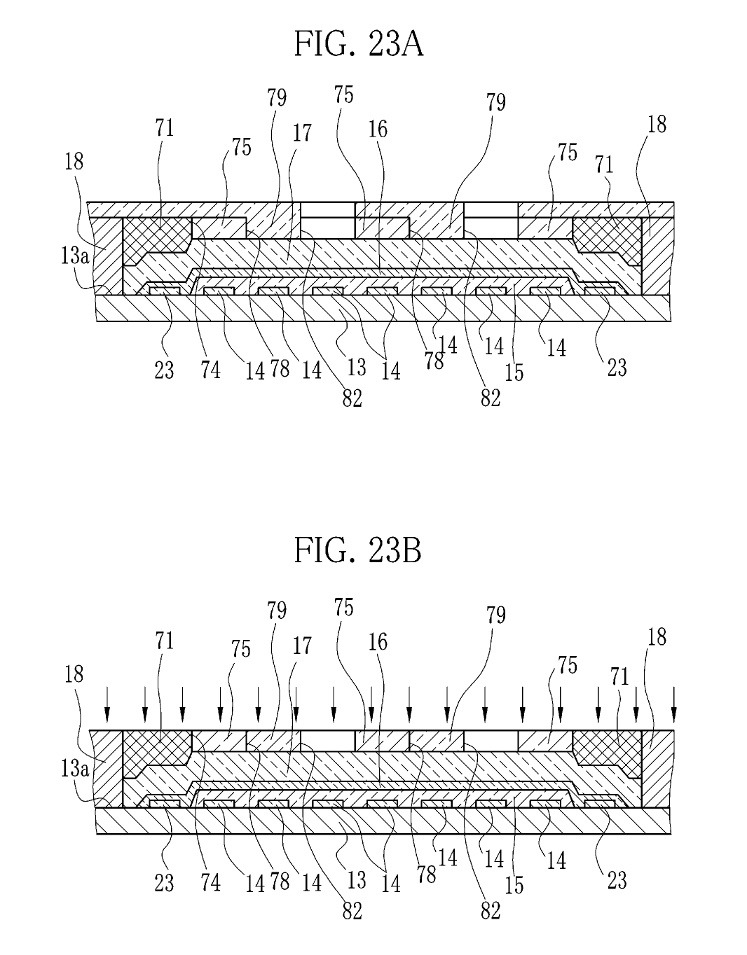

As shown in FIG. 23A, the photoresist layer 80 is removed in the subsequent photoresist removing step 66. The operations, conditions, solvent and removing liquid in this removing step 66 are identical to the photoresist removing step 57.

[Planarizing Step]

As shown in FIG. 23A and FIG. 23B, the first planarizing step 67 uses the CMP machine to polish and planarize the second color layer 79 until the polish stop layer 18, the light shield layer 71 and the first color layer 75 appear. The first planarizing step 67 shares the same polishing operation as the planarizing step 62. The polish stop layer 18 that has a higher resistance than the second color layer 79 detects the polishing end point, and facilitates leveling the second color layer 79 with the polish stop layer 18.

The first planarizing step 67 is followed by the third color layer forming step 68. As shown in FIG. 24A, formed in this step 68 is a third color layer 83 (for example, green color layer) that covers over the polish stop layer 18, the light shield layer 71, and the first and second color layers 75, 79 and fills the etching hole 82. Similar to the first color layer forming step, the spin coater is introduced to apply a color layer composition. This coating layer is then post-baked to the third color layer 83 using the hot plate.

Lastly, as shown in FIG. 24B, the third color layer 83 is polished and planarized until the polish stop layer 18 appears (second planarizing step 69). The second planarizing step 69 shares the same polishing operation with the planarizing steps 62, 67. The polish stop layer 18 retards the polishing rate, detecting the polishing end point. It is therefore possible to level the third color layer 83 with the polish stop layer 18 having a predefined height. In this manner, the first to third color layers 75, 79, 83 are arranged in the active pixel area 22 to constitute the color filter array that is flush with the polish stop layer 18.

Although the above embodiment includes three planarizing steps before the formation of the second and third color layers (or after the formation of the first and second color layers) and after the formation of the third color layer, these planarizing steps may be integrated and performed after the formation of the third color filter, so as to planarize the first to third color layers 75, 79, 83 at once. Even this single planarizing step can allow for leveling the first to third color layers 75, 79, 83 with the polish stop layer 18.

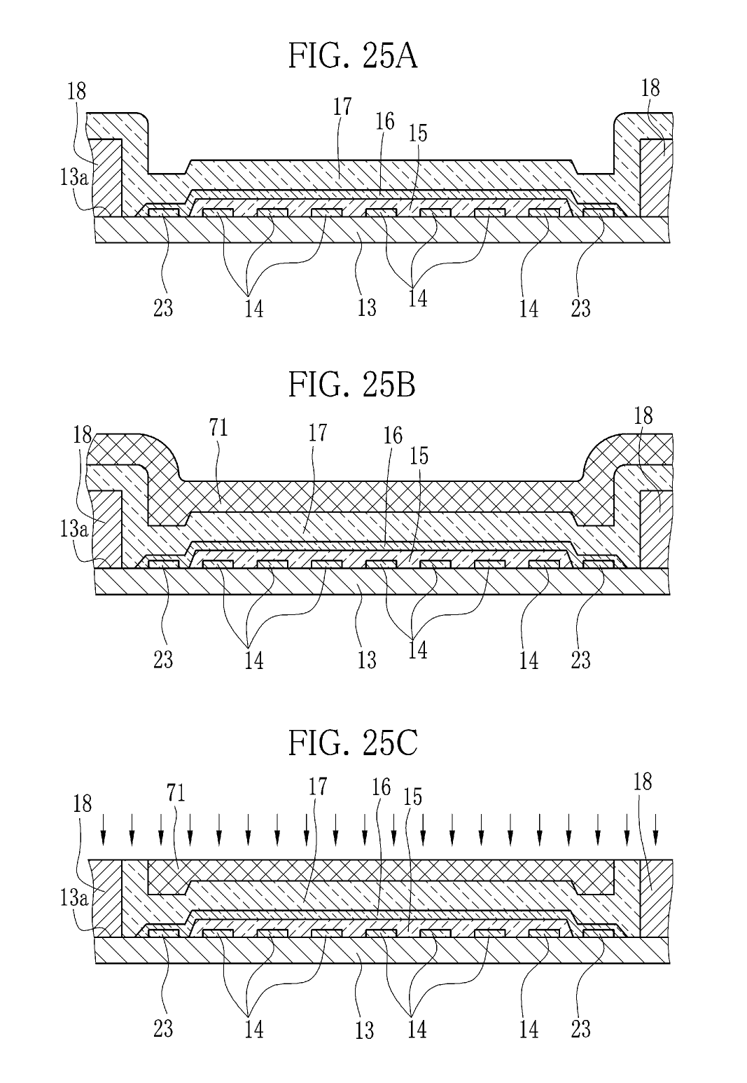

In forming the transparent insulating layer 17 of the above embodiment, the metal mask is placed on the polish stop layer 18 to keep the transparent insulating layer 17 within the polish stop layer 18. As shown in FIG. 25A to FIG. 25C, however, the transparent insulating layer 17 may be formed, without using the metal mask, to cover over the polish stop layer 18 and the upper electrode 16 (better shown in FIG. 25A). In this configuration, the light shield layer 71 is formed to cover the transparent insulating layer 17 (better shown in FIG. 25B). This light shield layer 71 is then polished and planarized, together with the transparent insulating layer 17, using the CMP machine until the polish stop layer 18 appears (better shown in FIG. 25C). Thereafter, the first to third color layers 75, 79, 83 are formed by the steps above. The polish stop layer 18 in this embodiment is preferably made of an inorganic material.

For better coating performance over uneven surfaces, the transparent insulating layer 17 is preferably formed by a liquid phase deposition method, such as spin coating or dip coating of acrylic resin, polyimide or similar resin, or a gas phase deposition method such as vapor deposition polymerization. In particular, for better protection to the light/electric power converter having the organic photoelectric conversion material, the transparent insulating layer 17 is preferably formed by the vapor deposition polymerization of polyparaxylene.

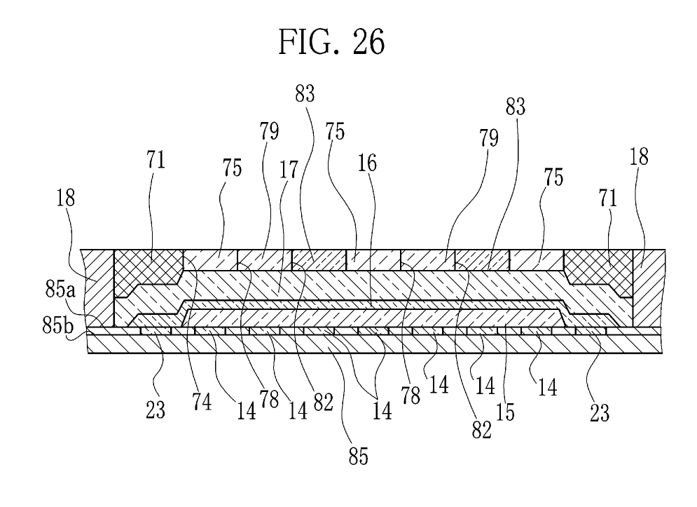

While the semiconductor substrate 13 has the top surface 13a that functions as the reference plane and the support for the lower electrodes 14 and the upper electrode pads 23, it is possible to use a multi-layer semiconductor substrate 85, shown in FIG. 26, having a reference surface 85b to support the lower electrodes 14 and the upper electrode pads 23 below a top surface 85a. In this instance, the lower electrodes 14 and the upper electrode pads 23 are exposed from the top surface 85a. Subsequently, similar to the above embodiment, the lower electrodes 14 are covered with the intermediate layer 15, and the upper electrode pads 23 are covered with the upper electrode 16.

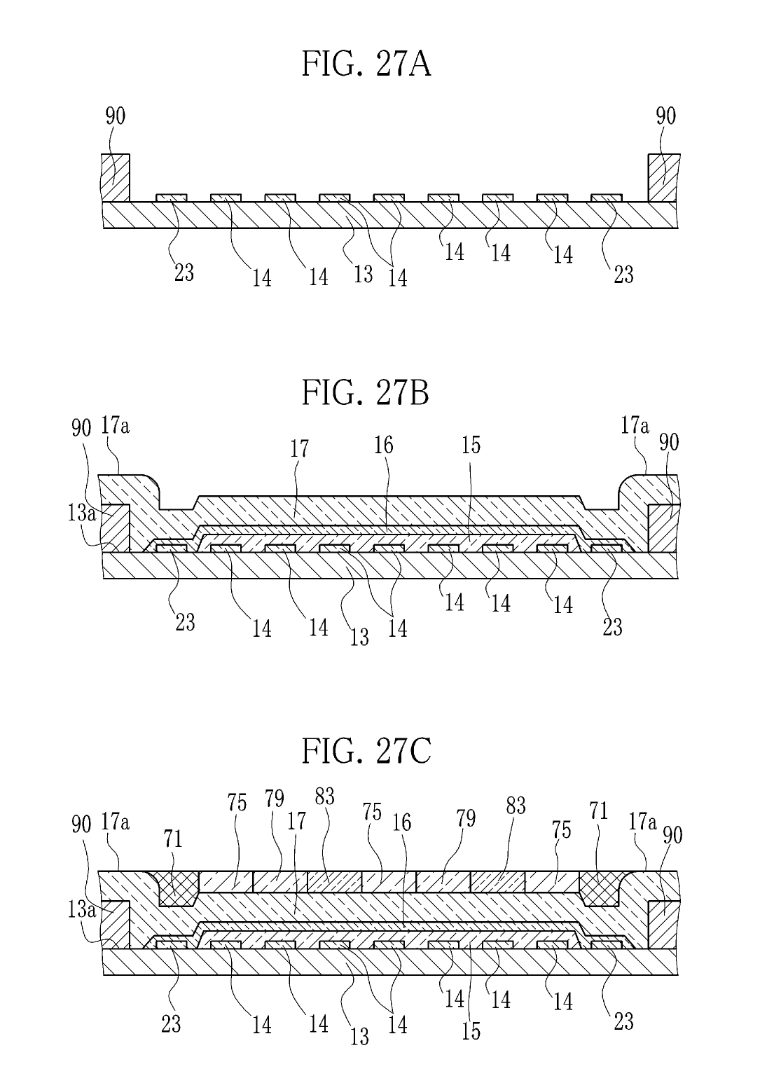

Although the structure for end point detection in the planarizing operation is composed of only the polish stop layer 18, the structure may be a stack of a partition wall 90 of similar configuration to the polish stop layer 18, and the transparent insulating layer 17. In this instance, as shown in FIG. 27A to FIG. 27C, the partition walls 90 are firstly formed in the same manner as the polish stop layer forming process 33 (FIG. 27A). After the formation of the lower electrodes 14, the intermediate layer 15 and the upper electrode 16, the transparent insulating layer 17 is formed over the partition walls and the upper electrode 16 without using a metal mask (FIG. 27B). The partition walls 90 needs to be lower than the polish stop layer 18 by the thickness of the transparent insulating layer 17. The subsequent process steps are the same as those in the former embodiment. The first to third color layers 75, 79, 83 are leveled with the transparent insulating layer 17 on the partition walls 90 (FIG. 27C), and the same effect as the above embodiment can be achieved. The structure is, however, not limited to the stack of the partition wall 90 and the transparent insulating layer 17, but may be of three-layered or more.

Since the transparent insulating layer 17 of this instance functions as the polish stop layer, the partition walls 90 may not be made from an extremely-resistant material but an easy-to-shape material. Such a material is also advantageous in reducing the production cost. Especially, a general photoresist material or a similar organic material allows for forming the partition wall 90 only through the photolithography process or, in other words, for omitting the dry-etching operation, and leads to further reduce the production cost.

Even better, this configuration does not require the metal mask in forming the transparent insulating layer 17, and allows for further reduction of the production cost. The transparent insulating layer 17 is preferably a multilayer of any of aluminum oxide, silicon oxide, silicon nitride and nitride-oxide silicon formed by the plasma CVD method, the catalytic CVD method, the ALD method or the like. Since the transparent insulating layer 17 provides better coating performance over uneven surface and better resistance to polishing, the protection to the light/electric power converter 11 is more improved.

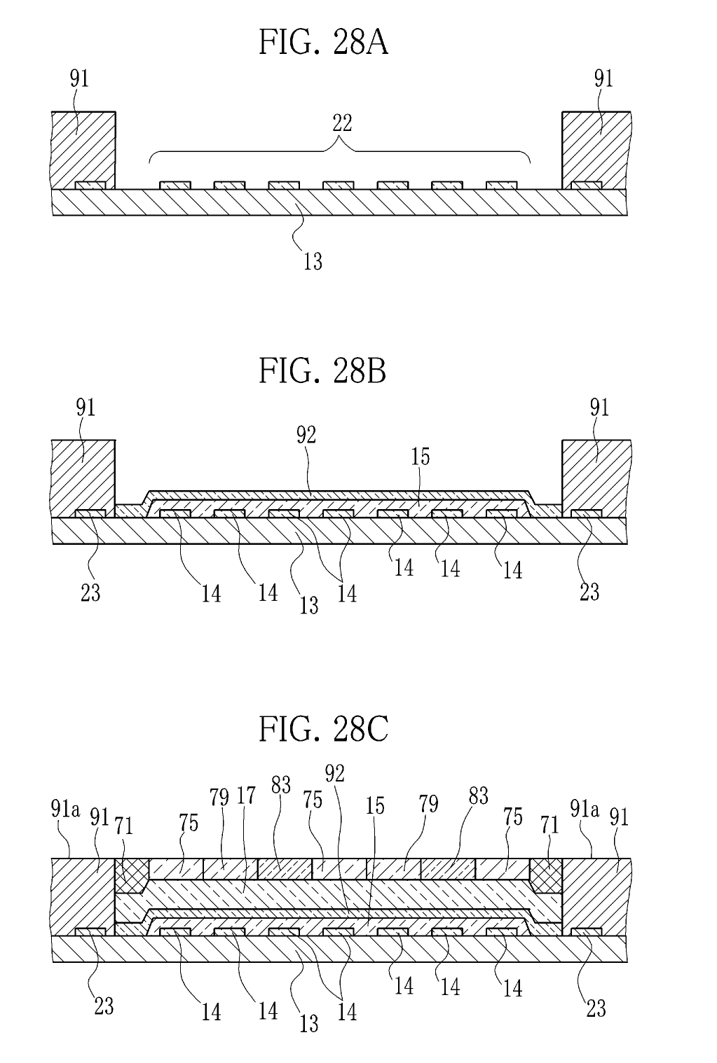

The structure for end point detection in planarizing operation is not limited to the above. For example, the polish stop layer 18 may be made from a conductive material, and connects the upper electrode 16 and the drive circuit 12. As shown in FIG. 28A to FIG. 28C, the same process steps as the former embodiments are performed until the formation of the electrode pads. In the polish stop layer forming process 33, on the other hand, a conductive material is used to form a polish stop layer 91 over the semiconductor substrate 13 and the upper electrode pads 23 outside the active pixel area 22 (FIG. 28A). The intermediate layer 15 of the photoelectric conversion material is then formed by the same operation as the former embodiments. In the subsequent step, the metal mask is placed only on the polish stop layer 91, and an upper electrode 92 is formed to cover over the intermediate layer 15 and come into contact with the polish stop layer 91 (FIG. 28B). As a result, the upper electrode 92 is connected to the drive circuit 12 by means of the conductive polish stop layer 91 and the upper electrode pads 23. Thereafter, the upper electrode 92 is covered with the transparent insulating layer 17, and the color filter array is formed through the same process as the former embodiments. The color filter array, or the first to third color layers 75, 79, 83 are then planarized to level with a top surface of an upper surface 91a of the conductive polish stop layer 91, and the same effect as the former embodiments is provided (FIG. 28C).

A preferable material for the conductive polish stop layer is Al, Ti, Mo, Ta, W or a similar metallic material, which are all easily processable by the RIE or a similar anisotropic etching method and allow for precise patterning.

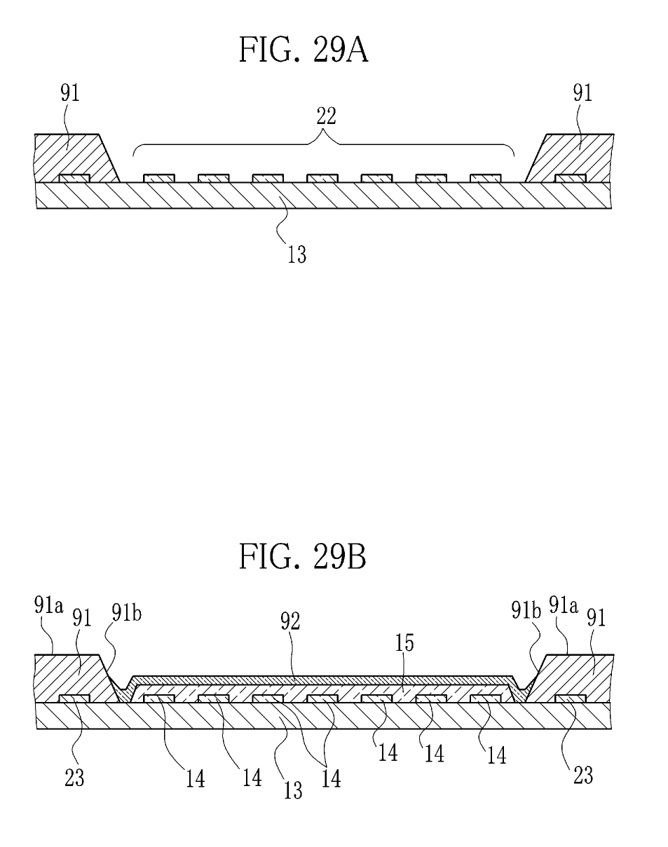

As shown in FIG. 29, the polish stop layer 91 may have a sloping inner wall 91b (better shown in FIG. 29A). Specifically, this inner wall 91b inclines to the active pixel area 22, and extends the contact area of the polish stop layer 91 and the upper electrode 92 formed thereon (FIG. 29B). This configuration provides secured connection of the upper electrode 92 and the drive circuit 12.

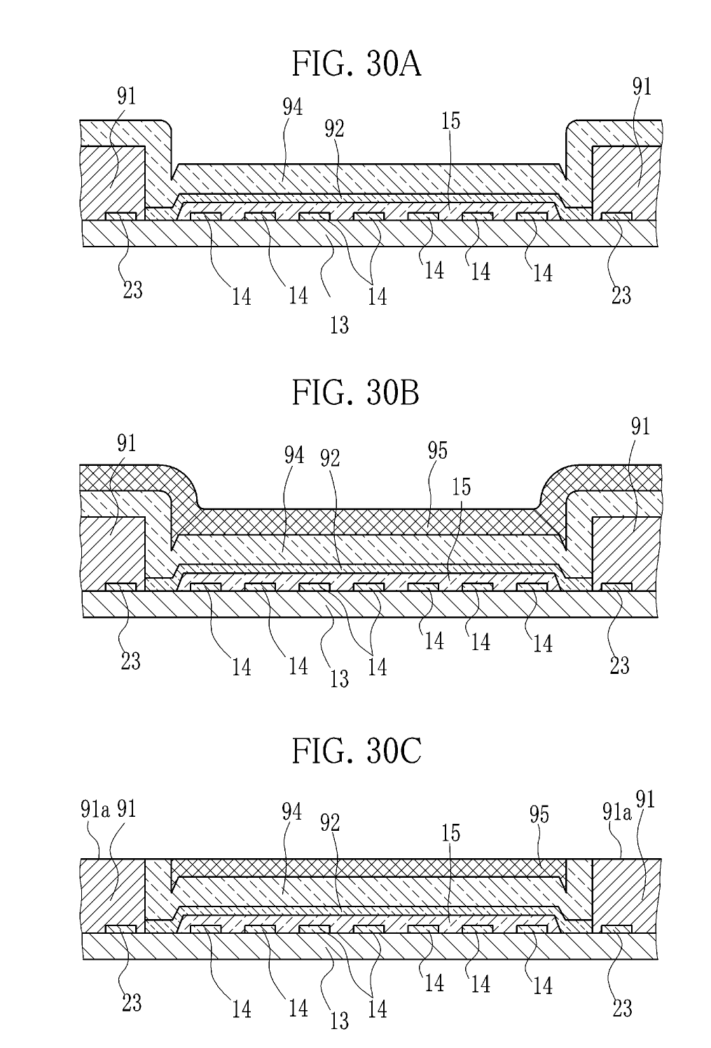

Alternatively, as shown in FIG. 30A, a transparent insulating layer 94 may be formed without using the metal mask after the step of FIG. 28B to form the upper electrode 92. The transparent insulating layer 94 is then completely covered with a light shield layer 95 (FIG. 30B). The transparent insulating layer 94 and the light shield layer 95 are planarized using the CMP machine or the like until an upper surface 91a of the polish stop layer 91 appears (FIG. 30C). The color filters may be then formed through the same procedures as the former embodiments.

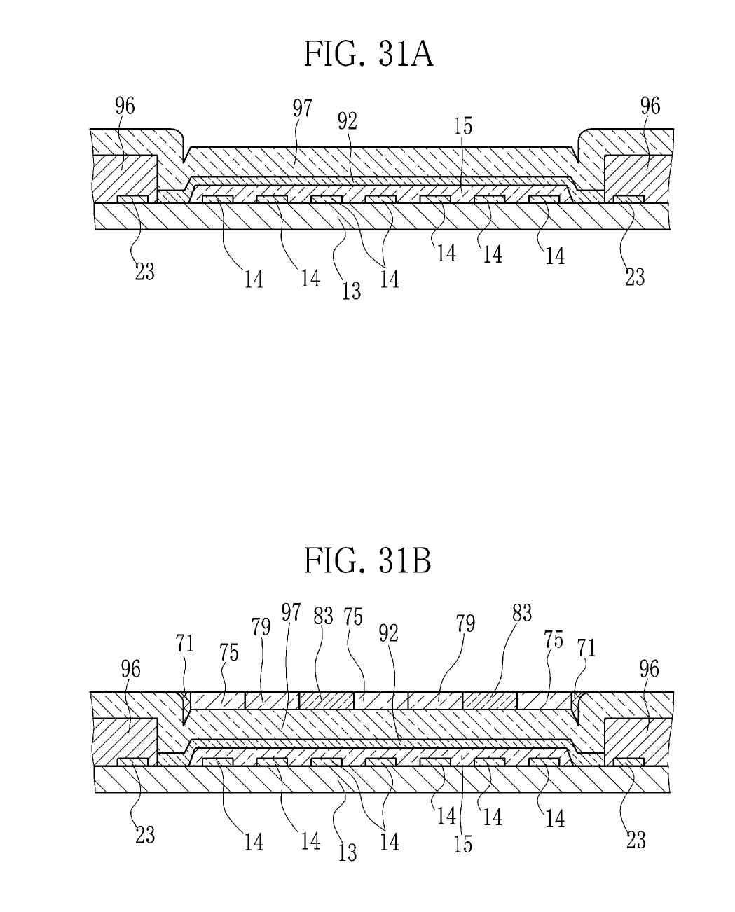

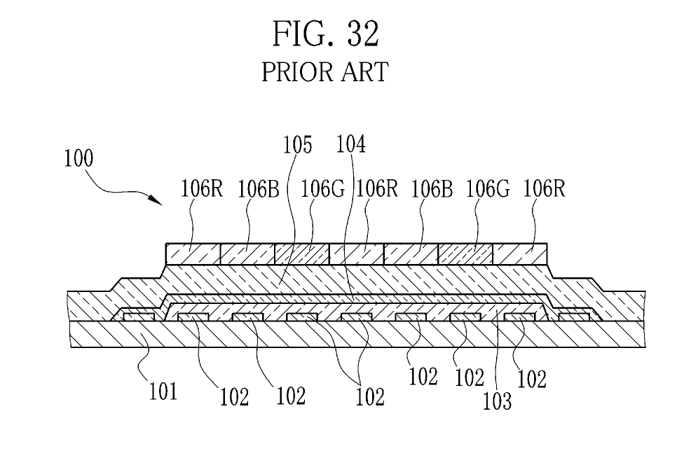

The structure for end point detection in planarizing operation may also be a stack of a partition wall having a similar structure as the conductive polish stop layer 91 and a transparent insulating layer. In this instance, partition walls 96 are firstly formed in the same manner as the polish stop layer 91 (FIG. 31A). After the formation of the lower electrodes 14, the intermediate layer 15 and the upper electrode 92, a transparent insulating layer 97 is formed over the entire lengths of the partition walls 96 and the upper electrode 92 without using a metal mask. Using this stack as the end point detection member, the first to third color layers 75, 79, 83 are planarized (FIG. 31B). The partition walls 90 are made lower than the polish stop layer 18 by the thickness of the transparent insulating layer 97. The subsequent color filter forming process and other processes are the same as those in the former embodiment. The structure is, however, not limited to the stack of the partition wall 96 and the transparent insulating layer 97, but may be the stack of any layers located above the intermediate layer 15.

In the above embodiments, the light shield layer of black colorant composition is formed around the active pixel area. The light shield layer may, however, be replaced with one of the first to third color layers which is elongated to surround the active pixel area. In this instance, it is possible to skip the light shield layer forming step 50, the patterning step 55, the etching step 56 and the photoresist removing step 57, and to start the color filter forming process 37 from the first color layer forming step 58. In the color layer forming step 58, the first color layer is formed to cover the polish stop layer 18 and the transparent insulating layer 17. The subsequent process steps are the same as the former embodiments.

Although the color layers of the former embodiments are planarized by the polishing (CMP) method in the planarizing step, they may be planarized by overall etching (etch back process) using the same procedures as the above mentioned dry-etching method.

[Colorant Composition]

An exemplary colorant composition for the color filter array is described hereafter. A typical colorant composition contains a photocurable component, which can be removed by the dry etching in the patterning operation. The colorant composition, as it has few or no photocurable component, leads to deepen the color of the colorant. Accordingly, this type of colorant composition allows the production of an ever-thinner color filter array without lowering the spectral transmission characteristics. The colorant composition is preferably a nonphotosensitive curable composition having no photocurable component, or a thermosetting composition.

A preferable thermosetting composition contains the colorant and a thermosetting compound, with a colorant concentration in the range of 50-100 mass % in total solid content. It is possible to reduce the thickness of the color filter by increasing the colorant concentration.

[Colorant]

The colorant may be one or a mixture of any conventional dyes and pigments.

The pigment can either be inorganic or organic. For better permeability, the pigment with a smaller average particle size is preferred. In further view of handling, the average particle size of the pigment is preferably in the range of 0.01-0.1 μm, and yet preferably 0.01-0.05 μm.

Preferable pigments, though not limited thereto, are as follows:

C.I. pigment yellow 11, 24, 108, 109, 110, 138, 139, 150, 151, 154, 167, 108, 185;

C.I. pigment orange 36, 71;

C.I. pigment red 122, 150, 171, 175, 177, 209, 224, 242, 254, 255, 264;

C.I. pigment violet 19, 23, 32;

C.I. pigment blue 15:1, 15:3, 15:6, 16, 22, 60, 66;

C.I. pigment green 7, 36, 58.

A dyestuff, when used as the colorant, is uniformly dissolved in the thermosetting composition to have a nonphotosensitive thermosetting colorant composition.

Any types of dyestuffs for conventional color filters can be used in the present invention.

In particular, pyrazole azo dyestuffs, anilino azo dyestuffs, triphenylmethane dyestuffs, anthraquinone dyestuffs, anthrapyridone dyestuffs, benzylidene dyestuffs, oxonol dyestuffs, pyrazolo-triazole azo dyestuffs, pyridone azo dyestuffs, cyanine dyestuffs, phenothiazine dyestuffs, pyrrolo-pyrazole azomethine dyestuffs, xathene dyestuffs, phthalocyanine dyestuffs, penzopyrane dyestuffs and indigo dyestuffs.

A preferable colorant content for the thermosetting colorant composition is in the range of 30-60 mass % in total solid content. The colorant content of 30 mass % or above will achieve an appropriate hue of the color filter. The colorant content of 60 mass % or below will assure adequate curing that provides strength to a layer.

[Thermosetting Compound]

A thermosetting compound of any type can be used in the present invention insofar as it is curable by heat, and an example is a compound containing a thermosetting functional group. In particular, a preferable thermosetting compound contains at least one of an epoxy group, a methylol group, an alkoxymethyl group and an acyloxymethyl group.

A still preferable thermosetting compound may be any of (a) an epoxy compound, (b) a melamine, guanamine, glycoluryl or urea compound having at least one substituent among the methylol group, the alkoxymethyl group and the acyloxymethyl group, and (c) a phenol, naphthol, or hydroxy-anthracene compound having at least one substituent among the methylol group, the alkoxymethyl group and the acyloxymethyl group. Especially preferable among these is a polyfunctional epoxy compound.

A total content of the thermosetting compound in the thermosetting colorant composition is, though it depends on the material used, preferably in the range of 0.1-50 mass %, and yet preferably 0.2-40 mass %, and still more preferably 1-35 mass % in total solid content.

[Additives]

Without undermining the effect of the present invention, the thermosetting colorant composition may contain various additives, such as binders, curing agents, curing catalysts, solvents, fillers, polymer compounds, surfactants, adhesion promoters, antioxidants, ultraviolet absorbers, anti-aggregation agents and dispersants.

[Binder]

A binder is often added in preparing a pigment dispersant. Any conventional binder can be used insofar as it shows no alkali solubility but is soluble in organic solvents.

The binder is preferably a linear organic high molecular weight polymer, and soluble in organic solvents. The linear organic high molecular weight polymer of this type may be a polymer with a carboxyl acid side chain, such as a methacrylic acid copolymer, an acrylic acid copolymer, an itaconic acid copolymer, a crotonic acid copolymer, a maleic acid copolymer, or a partially esterified maleic acid copolymer as described in, for example, Japanese Patent Laid-open Publications No. 59-44615, No. 59-53836 and No. 59-71048 and Japanese Patent Application National Publications No. 54-34327, No. 58-12577 and No. 54-25957, and a acid cellulose derivative with a carboxyl acid side chain.

For better heat resistance, a preferable binder among these is a polyhydroxystyrene-based resin, a polysiloxane-based resin, an acrylic-based resin, an acrylamide-based resin and an acrylic/acrylamide copolymer resin, and in further view of development controllability, a more preferable binder is the acrylic-based resin, the acrylamide-based resin or the acrylic/acrylamide copolymer resin.

The acrylic-based resin is preferably a copolymer of a benzyl (meth)acrylate monomer, a (meth)acrylic acid monomer, a hydroxyethy (meth)acrylate monomer and a (meth)acrylamide, such as benzyl methacrylate/methacrylic acid copolymer, benzyl methacrylate/benzyl methacrylamide copolymer, KS resist-106 (from Osaka organic chemical industry Ltd.) or Cyclomer-P (from Daicel chemical industries, Ltd.). The above mentioned colorant is heavily dispersed in these binders to offer adhesion to the lower layers, and also improve the coated surface condition in spin coating and slit coating.

[Curing Agent]

In using an epoxy resin as the thermosetting compound, a curing agent is preferably added. Since the curing agent for the epoxy resin comes in a variety of types, different in characteristics, working life of the resin/curing agent mixture, viscosity, curing temperature, curing time and heat, an appropriate curing agent needs to be selected on the intended purpose, use conditions, process conditions and others. The curing agent is described in detail in the chapter 5 of “Epoxy Resins” (Shokodo Co., Ltd.) edited by Hiroshi Kakiuchi, and the examples are as follows:

Tertiary amines and borontrifluoride-amine complexes as the type having a catalytic role; polyamines and acid anhydrides as the type that stoichiometrically reacts to a functional group of the epoxy resins; diethylene triamine and polyamide resins as the room-temperature curing type; diethylaminopropylamine and tris(dimethylaminomethyl)phenol as the low-temperature curing type; and phthalic anhydride and meta-phenylenediamine as the high-temperature curing type. When classified by chemical structure, the examples are diethylene triamine as an aliphatic polyamine; meta-phenylenediamine as an aromatic polyamine; tris(dimethylaminomethyl)phenol as a tertiary amine; phthalic anhydride, polyamide resins, polysulfide resins and borontrifluoride-amine complexes as an acid anhydride; phenol resins and dicyandiamide as an initial condensation product of synthetic resins.

These curing agents react, when heated, to an epoxy group and polymerize to increase a crosslink density, and then become cured. To reduce the thickness of the layer, the binder and the curing agent need to be as few as possible. Especially, the amount of the curing agent is restricted preferably to 35 mass % or less of the thermosetting compound, and yet preferably to 30 mass % or less, and most preferably to 25 mass % or less.

[Curing Catalyst]

For a greater density of the colorant, the curing by the reaction of two epoxy groups is also effective, as well as the curing by the reaction of the curing agent and an epoxy group. Accordingly, a curing catalyst may be used, in place of the curing agent. The amount of the curing catalyst, to an epoxy resin having an epoxy equivalent weight of from about 150 to about 200, is preferably from one tenth to one hundredth on a mass basis, and yet preferably from one twentieth to one five-hundredth, and most preferably from one thirtieth to one two-hundred fiftieth.

[Solvent]

The thermosetting colorant composition of the present invention may contain one or more solvents. Any conventional solvents may be used insofar as they can achieve a needed solubility and a coating property of the thermosetting colorant composition.

[Dispersant]

A dispersant may be added to improve dispersion of the pigment. The dispersant is not particularly limited, but may be any of, for example, a cationic surfactant, a fluorinated surfactant and a polymer dispersant.

Examples of the dispersant are, for example, a phthalocyanine derivative (for example, EFKA-745 from EFKA Chemicals B.V. or SOLSPERSE 5000 from Lubrizol Japan Limited); an organosiloxane polymer (for example, KP341 from Shin-Etsu Chemical Co., Ltd.); a (meth)acrylic acid (co-)polymer (for example, POLYFLOW No. 75, No. 90, No. 95 from KYOEISHA CHEMICAL Co., Ltd.); a cationic surfactant (for example, W001 from Yusho Co., Ltd.); a nonionic surfactant, such as polyoxyethylene lauryl ether, polyoxyethylene stearyl ether, polyoxyethylene oleyl ether, polyoxyethylene octylphenyl ether, polyoxyethylene nonylphenyl ether, polyethylene glycol dilaurate, polyethylene glycol distearate or sorbitan fatty acid ester; an anionic surfactant (for example, W004, W005, W017 from Yusho Co., Ltd.); EFKA-46, EFKA-47, EFKA-47EA, EFKA polymer 100, EFKA polymer 400, EFKA polymer 401 and EFKA polymer 450 from Morishita & Co., Ltd.; a polymer dispersant (for example, Disperse Aid 6, Disperse Aid 8, Disperse Aid 15, Disperse Aid 9100 from SAN NOPCO Limited); a solsperse dispersant (for example, SOLSPERSE 3000, 5000, 9000, 12000, 13240, 13940, 17000, 24000, 26000, 28000 from Lubrizol Japan Limited); Adeka Pluronic L31, F38, L42, L44, L61, L64, F68, L72, P95, F77, P84, F87, P94, L101, P103, F108, L121, P-123 (all from ADEKA Corporation) and ISONET S-20 (from Sanyo Chemical Industries, Ltd.).

These dispersants may be used alone or in combination. The amount of the dispersant in the thermosetting colorant composition is preferably 0.1-50 pts. mass relative to 100 pts. mass pigment.

[Other Additives]

Similarly, the nonphotosensitive curable composition of the present invention may contain various additives, where needed, such as filters and others among those mentioned above.

[Photoresist]

As described, in forming the first to third color layers by the dry etching method, the photoresist is used to form a resist pattern. Preferably, the photoresist is also used to form a resist pattern in the removing step.

The material of the photoresist (or photosensitive resin layer) may be selected from conventional positive resist compositions sensitive to ultraviolet rays (G-ray, H-ray and I-ray), far-infrared rays including the excimer lasers, electron rays, ion beams, X-rays and other types of radiation. A preferable exposure source for this photosensitive resin layer composition is G-ray, H-ray or I-ray, and the I-ray is particularly preferred among these.

Preferably, this positive photosensitive resin composition may contain a quinonediazide compound and an alkali soluble resin. This type of photosensitive resin composition is used as the positive photoresist because of its nature to convert the quinonediazide group into a carboxyl group under radiation of light of 500 nm or blow, and thus change from the alkali insoluble phase to an alkali soluble phase. The resultant photoresist is excellent in resolution, and thus often used in the manufacture of semiconductor integrated circuits. The quinonediazide compound may be, for example, a naphthoquinone diazide compound.

It is possible to add various additives as required to photosensitive resin compositions. Examples of the additives are those which have been described with the colorant curable compositions.

While the above embodiments are directed to the additive color filters of red, green and blue, the present invention is also applicable to subtractive color filters of cyan, magenta and yellow.

In practice, the semiconductor substrate for the solid state imaging device is a silicon wafer, which is firstly processed to have a plurality of solid state imaging devices and then cut into discrete solid state imaging devices.

While the light/electric power converter is used in the solid state image pick-up device in the above embodiments, the light/electric power converter of the present invention can be used in other types of devices, such as organic luminescence (EL) display devices.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A light/electric power converter having a substrate with an active pixel area composed of a plurality of pixels, each of which includes a lower electrode on said substrate, an intermediate layer of an organic photoelectric conversion material that covers over said lower electrode, an upper electrode on said intermediate layer and a color filter above said upper electrode, said light/electric power converter comprising:
a structure disposed on said substrate and outside said active pixel area, and having an upper surface level with an upper surface of said color filter.

2. The light/electric power converter of claim 1, wherein said upper surface has a higher resistance to polishing than said color filter.

3. The light/electric power converter of claim 1, wherein said intermediate layer extends all over said active pixel area.

4. The light/electric power converter of claim 1, wherein said upper electrode extends all over said active pixel area.

5. The light/electric power converter of claim 1, further comprising a transparent insulating layer extending between said upper electrode and said color filter and all over said active pixel area.

6. The light/electric power converter of claim 1, wherein said structure has a rectangular frame shape for surrounding said active pixel area.

7. The light/electric power converter of claim 2, wherein said structure is made of silicon oxide, silicon nitride or nitride-oxide silicon.

8. The light/electric power converter of claim 2, wherein said structure is made of a conductive material, and connected to said upper electrode.

9. The light/electric power converter of claim 2, wherein said structure comprises a stack of two or more materials.

10. The light/electric power converter of claim 5, wherein said structure comprises a stack of two or more materials including the same material as said transparent insulating layer.

11. The light/electric power converter of claim 8, wherein said structure comprises a stack of two or more materials including a conductive material.

12. The light/electric power converter of claim 1, further comprising a drive circuit attached to said substrate to position below said lower electrode and connected to said lower electrode.

13. A solid state imaging device comprising said light/electric power converter of claim 12, and configured to read out an electrical charge from said photoelectric conversion material through said drive circuit.

14. The solid state imaging device of claim 13, wherein said drive circuit includes a CCD type or CMOS type signal read-out circuit.
